(19) United States
(12) Patent Application Publication
(10) Pub. No.: US 2019/0366755 A1
(43) Pub. Date: Dec. 5, 2019

(54) FEEDING PENCIL

(71) Applicant: TOKIWA CORPORATION, Nakatsugawa-shi (JP)

(72) Inventor: Yoshikazu TANI, Kawaguchi-shi (JP)

(73) Assignee: TOKIWA CORPORATION, Nakatsugawa-shi (JP)

(21) Appl. No.: 16/423,039

(22) Filed: May 27, 2019

(30) Foreign Application Priority Data
May 30, 2018 (JP) 2018-103250

(51) Int. Cl. B43K 21/08; B43K 21/00; B43K 21/24

(52) U.S. Cl. CPC B43K 21/08; B43K 21/24; B43K 21/006

(57) ABSTRACT

A feeding pencil includes a main body including a main body barrel having a tubular shape, a front barrel detachably engaged with the main body barrel, and a cartridge disposed in the front barrel to receive a drawing material. The cartridge includes a tubular portion provided on a rear side of the cartridge, the main body includes an insertion portion provided on a front side of the main body and configured to be engaged with the tubular portion. When the cartridge is tilted from the main body, an engagement between the tubular portion and the insertion portion is released.

### CROSS-REFERENCE TO RELATED APPLICATIONS

This application claims priority to Japanese Patent Application No. P2018-103250, filed May 30, 2018, the entire contents of which are incorporated herein by reference.

### TECHNICAL FIELD

Feeding pencils with dischargeable drawing material.

### BACKGROUND

Japanese Unexamined Patent Publication No. 2004-329775 discloses a cosmetic container including a cosmetic cartridge detachably provided therein. A female thread portion is formed on an inner peripheral surface of the storage container, and a male thread portion is formed on an outer peripheral surface of the cosmetic cartridge. A relative rotation between the storage container and the cosmetic cartridge in one direction causes the female thread portion of the storage container and the male thread portion of the cosmetic cartridge to engage with each other, thereby attaching the cosmetic cartridge to the storage container. On the other hand, when relative rotation between the storage container and the cosmetic cartridge in an opposite direction detaches the cosmetic cartridge from the storage container, the cosmetic cartridge is pulled out of the storage container.

### SUMMARY

So that components in the feeding pencil can be readily attached and detached for replacement of the components of the cosmetic container, an operation of relative rotation between the storage container and the cosmetic cartridge may be used to detach the cosmetic cartridge from the storage container.

The feeding pencil should be configured to allow for components to be readily attached and detached.

An example feeding pencil may comprise a main body including a main body barrel having a tubular shape, a front barrel configured to be detachably engaged with the main body barrel, and a cartridge disposed in the front barrel and loaded with a drawing material. The cartridge includes a first engagement portion provided on a rear side of the cartridge, and the main body includes a second engagement portion provided on a front side of the main body and configured to be engaged with the first engagement portion. In some examples, when the cartridge is tilted from the main body, an engagement between the first engagement portion and the second engagement portion is released.

The engagement between the first engagement portion provided on the cartridge and the second engagement portion provided on the main body is released when the cartridge is tilted from the main body. This release of engagement allows the cartridge to detach from the main body. The example feeding pencil may be configured to allow the cartridge to readily detach from the main body by the operation of tilting the cartridge from the main body, rather than an operation of rotating the cartridge, for example. The detachment of the cartridge from the main body by tilting the cartridge can increase manufacturing efficiencies during assembly of the feeding pencil.

The main body may further include a slider provided in the main body barrel and which is slidable by a fixed amount relative to the main body barrel. In some examples, the slider may be disposed behind the cartridge, and the second engagement portion may be provided on a front side of the slider. When the cartridge is tilted from the slider with the front barrel detached from the main body barrel and the slider is moved forward by the fixed amount relative to the main body barrel, the engagement between the first engagement portion and the second engagement portion may be released. This configuration allows the cartridge to be readily detached with the front barrel detached from the main body barrel and the slider moved forward by the fixed amount.

In some examples, the front barrel may be engaged with the main body barrel and may be rotatable relative to the main body barrel. The cartridge may include a pipe member loaded with the drawing material, a mobile body configured to push out the drawing material loaded in the pipe member forward, and a holder configured to hold the mobile body behind the pipe member. Additionally, the slider may be moved forward by the fixed amount relative to the main body barrel to cause the pipe member to engage with the front barrel in a rotational direction, and a relative rotation between the front barrel and the main body barrel in one direction with the pipe member engaged with the front barrel in the rotational direction may cause the drawing material to move forward in the front barrel. When the slider is moved forward by the fixed amount relative to the main body barrel, the pipe member is moved forward accordingly. Then, with the pipe member engaged with the front barrel in the rotational direction, the relative rotation between the front barrel and the main body barrel in the one direction causes the drawing material to move forward. In some examples, a structure in which the drawing material is moved forward by the relative rotation between the front barrel and the main body barrel may exhibit substantially the same effects as the described above.

Either one of the first engagement portion and the second engagement portion may include a cutout hole formed through a tubular portion, and the other engagement portion may include an insertion portion that is configured to be inserted into and engaged with the cutout hole. The insertion portion and the cutout hole allow the engagement between the first engagement portion and the second engagement portion to be readily made.

In some examples, the first engagement portion may be the tubular portion, and the second engagement portion may be the insertion portion. When the second engagement portion of the main body is the tubular portion having the cutout hole, the cartridge is detached from the main body by being tilted from the main body, which may decrease the mechanical strength of the second engagement portion of the main body due to repeated attachment and detachment. This in turn may decrease the strength of the engagement between the first engagement portion and the second engagement portion, or the integrity of the second engagement portion may be compromised. On the other hand, when the first engagement portion of the cartridge is the tubular portion having the cutout hole, the mechanical strength of the second engagement portion after repeated attachment and detachment may be maintained.

In some examples, when the cartridge is tilted from the main body to cause the tubular portion to separate from the insertion portion while causing the insertion portion to expand the tubular portion, the cartridge may be detached from the main body. This configuration allows the insertion portion to expand the cutout hole of the tubular portion. Therefore, when the cartridge is tilted from the main body, the tubular portion is expanded by the insertion portion. This expansion causes the tubular portion to separate from the insertion portion and accordingly causes the cartridge to detach from the main body.

In some examples, the insertion portion may have a cylindrical shape. This configuration allows the tubular portion to be less liable to be caught in the insertion portion when the cartridge is detached from the main body by being tilted from the main body, allowing the cartridge to readily detached.

A projection may be formed on an outer surface of the insertion portion, and a raised portion may be formed on an inner wall surface of the cutout hole, the projection being engaged with the raised portion. Additionally, the projection and the raised portion may be provided on opposite sides of the tubular portion from each other in a radial direction of the tubular portion. This configuration allows the cartridge to detach from the main body by being tilted to not only one side in the radial direction but also the other side opposite to the one side. This in turn allows the cartridge to be readily detached from the main body.

According to the examples described herein, various components of the feeding pencil can be readily attached and detached.

### BRIEF DESCRIPTION OF THE DRAWINGS

FIG. 1 is a side view of an example feeding pencil;

FIG. 2 is a side view of the feeding pencil illustrated in FIG. 1, where one cartridge has been removed;

FIG. 3 is a longitudinal cross-sectional view of the feeding pencil illustrated in FIG. 1;

FIG. 4 is a perspective cross-sectional view of the feeding pencil illustrated in FIG. 1;

FIG. 5 is a perspective cross-sectional view of the feeding pencil illustrated in FIG. 4, where one slider is moved forward;

FIG. 6 is a longitudinal cross-sectional view of a front barrel;

FIG. 7A is a side view of a middle barrel;

FIG. 7B is a longitudinal cross-sectional view of the middle barrel;

FIG. 8 is a cross-sectional view taken along line A-A of FIG. 1;

FIG. 9A is a perspective view of a holder,

FIG. 9B is a side view of the holder illustrated in FIG. 9A;

FIG. 10A is a side view of the holder illustrated in FIG. 9A as viewed from a direction different from the direction of FIG. 9B;

FIG. 10B is a cross-sectional view taken along line B-B of FIG. 9B;

FIG. 11A is an enlarged perspective view of a portion around a rear end of the holder illustrated in FIG. 9A;

FIG. 11B is a side view of the portion around the rear end of the holder illustrated in FIG. 11A;

FIG. 11C is a rear view of the holder as viewed from the rear end of the holder;

FIG. 12A is a perspective, partial cross-sectional view of the holder illustrated in FIG. 9A;

FIG. 12B is a perspective, partial cross-sectional view of the holder illustrated in FIG. 12A, showing the portion around the rear end of the holder in an enlarged manner;

FIG. 13A is a perspective view of a mobile body;

FIG. 13B is a side view of the mobile body;

FIG. 14A is a side view of a pipe member,

FIG. 14B is a longitudinal cross-sectional view of the pipe member;

FIG. 15 is a perspective view of a slider,

FIG. 16A is a side view of the slider illustrated in FIG. 15;

FIG. 16B is a side view of the slider illustrated in FIG. 15 as viewed from a direction different from the direction of FIG. 16A;

FIG. 17A is an enlarged perspective view of a portion around a front end of the slider illustrated in FIG. 15;

FIG. 17B is a side view of the portion around the front end of the slider illustrated in FIG. 17A;

FIG. 17C is a side view of the portion around the front end of the slider illustrated in FIG. 17A as viewed from a direction different from the direction of FIG. 17B;

FIG. 18A is a side view of the slider and the cartridge;

FIG. 18B is a side view of the slider and the cartridge illustrated in FIG. 18A as viewed from a direction different from the direction of FIG. 18A;

FIG. 19A is an enlarged side view of main portions of the slider and the cartridge illustrated in FIG. 18A;

FIG. 19B is a cross-sectional view taken along line D-D of FIG. 19A;

FIG. 20A is a longitudinal cross-sectional view of a main body barrel;

FIG. 20B is a side view of the main body barrel;

FIG. 20C is a cross-sectional view taken along line C-C of FIG. 20B;

FIG. 21A is a partial longitudinal cross-sectional view of the feeding pencil, where the front barrel is detached from the main body barrel, and the slider is moved forward by a fixed amount relative to the main body barrel;

FIG. 21B is a partial longitudinal cross-sectional view of the feeding pencil, where the cartridge is tilted from the slider in the state illustrated in FIG. 21A;

FIG. 22A is a perspective view of the cartridge and the slider of FIG. 21B;

FIG. 22B is an enlarged perspective view of main portions of the cartridge and the slider of FIG. 22A;

FIG. 23A is a side view of the cartridge and the slider, where the cartridge is further tilted from the slider of FIG. 22A;

FIG. 23B is a side view of the cartridge and the slider illustrated in FIG. 23A as viewed from a direction different from the direction of FIG. 23A;

FIG. 24 is an enlarged side view of main portions of the cartridge and the slider illustrated in FIG. 23A;

FIG. 25A is a perspective view of the cartridge and the slider, where the cartridge is detached from the slider;

FIG. 25B is an enlarged perspective view of main portions of the cartridge and the slider illustrated in FIG. 25A;

FIG. 26A is a perspective view of the cartridge and the slider, before the cartridge is attached to the slider,

FIG. 26B is an enlarged perspective view of the main portions of the cartridge and the slider of FIG. 26A;

FIG. 27A is a perspective view of the cartridge and the slider, where the cartridge is attached to the slider;

FIG. 27B is an enlarged perspective view of main portions of the cartridge and the slider of FIG. 27A;

FIG. 28A is a side view of an example tubular portion with the insertion portion engaged with the tubular portion;

FIG. 28B is a cross-sectional view taken along line E-E of FIG. 28A; and

FIG. 29 is a side view of the cartridge and the slider, where the cartridge is tilted from the slider of FIG. 28A.

### DETAILED DESCRIPTION

Hereinafter, various examples will be described with reference to the drawings. In the following description, the same or equivalent components are denoted by the same reference numerals, and any redundant description will be omitted as appropriate.

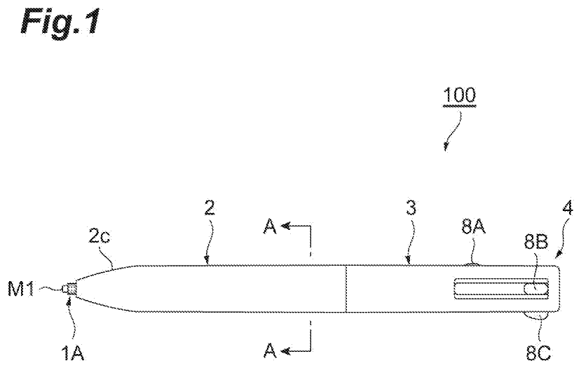

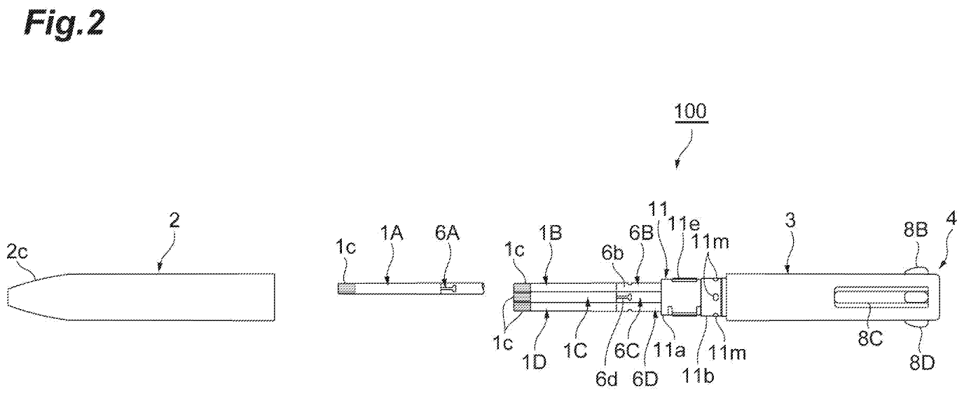

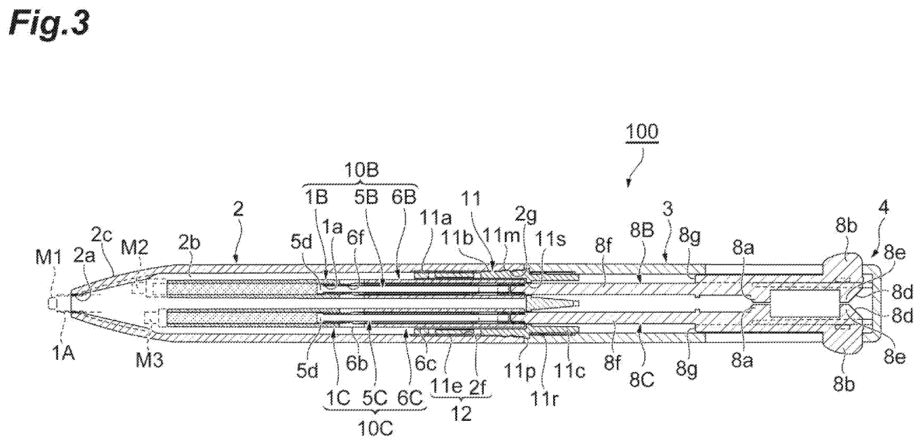

FIG. 1 is a side view of an example feeding pencil. FIG. 2 is a side view of the feeding pencil illustrated in FIG. 1, showing a state where one cartridge is taken out of the feeding pencil. FIG. 3 is a longitudinal cross-sectional view of the feeding pencil illustrated in FIG. 1. As illustrated in FIG. 1 to FIG. 3, the feeding pencil 100 may include a multi-color pencil configured to discharge (i.e. push out), in response to an operation made by a user, any one of a plurality of drawing materials M1 to M4 loaded in respective four pipe members 1A to 1D. In some examples, the drawing materials M1 to M4 refer to drawing materials having mutually different colors.

The drawing materials M1 to M4 may include various rod-shaped cosmetics such as lipstick, lip gloss, eyeliner, eyebrow, lip liner, blush, concealer, beauty stick, hair dye, and nail art, a stationery rod-shaped core, or the like. Furthermore, one or more of the drawing materials M1 to M4 may include a flexible (e.g. semi-solid, soft-solid, soft, jelly, mousse, paste containing these, or the like) rod-shaped object. In some examples, one or more of the drawing materials M1 to M may include a narrow rod-shaped object having an outer diameter of 1 mm or less, a general rod-shaped object having an outer diameter of 1.5 mm to 3.0 mm, or a thick rod-shaped object having an outer diameter of 4.0 mm or more.

The feeding pencil 100 may include a front barrel 2 including the pipe members 1A to 1D loaded with the drawing materials M1 to M4, and a main body 4 including a main body barrel 3 that is connected to a rear end portion of the front barrel 2 and is engaged with the front barrel 2 in such a way as to be rotatable relative to the front barrel 2, as outer members. In one or more of the examples, an “axis” may be understood to refer to a center line of the feeding pencil 100 extending in a longitudinal direction of the feeding pencil 100, and an “axial direction” may be understood to refer to a direction along the axis, that is, the longitudinal direction. Additionally, a “front side” may be understood to refer to a side from the main body 4 toward the front barrel 2 in the axial direction, and a “rear side” may be understood to refer to a side from the front barrel 2 toward the main body 4 in the axial direction. A “front end” may be understood to refer to an end on the front side of a certain component, and a “rear end” may be understood to refer to an end on the rear side of a certain component. Still further, “radial direction” may be understood to refer to a direction orthogonal to the axis, and a “circumferential direction” may be understood to refer to a direction along a ring centered on the axis. In some examples, it may be assumed that a feeding direction of the drawing materials M1 to M4 refers to a front (i.e. forward direction), and a direction opposite to the feeding direction refers to a rear (i.e. rearward direction).

As illustrated in FIG. 3, a mobile body 5B having a rod shape is screwed into the pipe member 1B and is held by a holder 6B having a tubular shape. The pipe member 1B, the mobile body 5B, and the holder 6B constitute a cartridge 10B replaceable with respect to the main body 4. The pipe member 1C may have the same configuration as the pipe member 1B has, and the pipe member 1C, a mobile body 5C, and a holder 6C constitute a cartridge 10C. The same applies to the pipe members 1A and 1D.

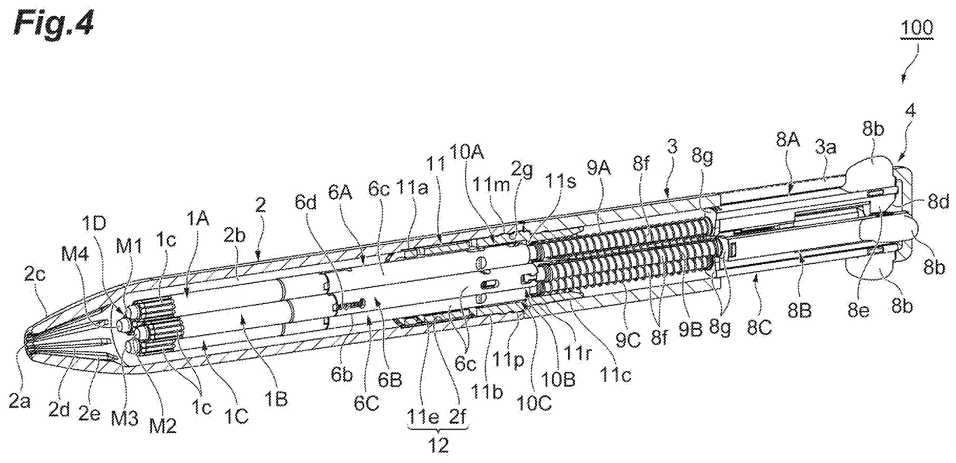

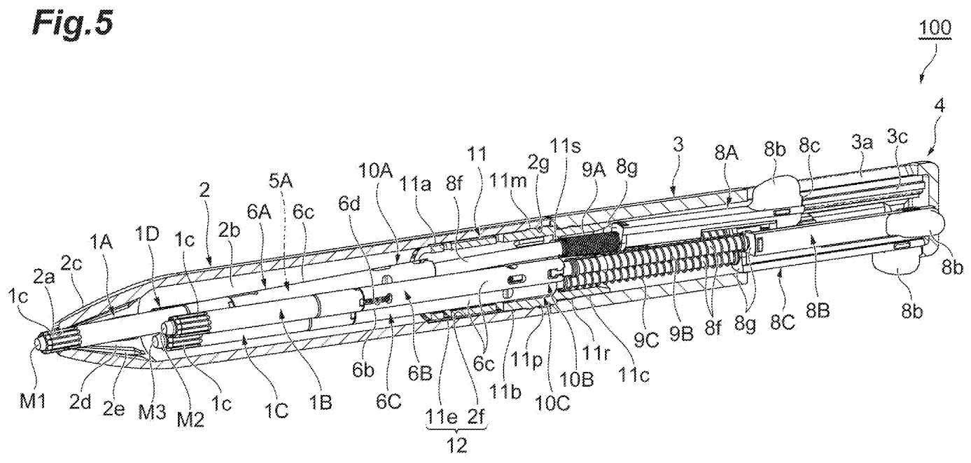

A slider 8B configured to be engaged with the holder 6B in the axial direction, and a spring 9B (see FIG. 4 and FIG. 5) configured to energize the slider 8B rearward, may be located behind the cartridge 10B. Similarly, a slider 8C and a spring 9C may be located behind the cartridge 10C, and a slider 8A and a spring 9A may be located behind the cartridge 10A. Additionally, a slider and a spring may be located behind a cartridge constituted by the pipe member 1D.

FIG. 4 is a perspective cross-sectional view of the example feeding pencil 100 illustrated in FIG. 1. FIG. 5 is a perspective cross-sectional view of the feeding pencil 100 of FIG. 4, showing a state where one slider 8A is moved forward. As illustrated in FIG. 4 and FIG. 5, the main body 4 includes four sliders such as the slider 8A provided therein and four springs such as the spring 9A each provided on a corresponding one of the four sliders. Inside the front barrel 2 are four pipe members 1A to 1D loaded respectively with the drawing materials M1 to M4, four mobile bodies such as the mobile body 5A, and four holders such as the holder 6A. The four pipe members, the four mobile bodies, the four holders, the four springs, and the four sliders mutually may have the same configuration except that different drawing materials M1 to M4 are loaded in each pipe member.

The four pipe members, the four mobile bodies, the four holders, the four springs, and the four sliders may be referred to as a pipe member 1, a mobile body 5, a holder 6, a spring 9, and a slider 8, respectively. Further, the four cartridges such as the cartridge 10A and the drawing materials M1 to M4 may be referred to as a cartridge 10 and a drawing material M, respectively.

A middle barrel 11 is engaged with a front end of the main body barrel 3 in such a way as to be synchronously rotatable with the main body barrel 3, and the middle barrel 11 has four holders 6 held therein. Further, the middle barrel 11 and the front barrel 2 are provided with a ratchet mechanism 12 that may be configured to restrict the relative rotation between the front barrel 2 and the main body barrel 3 (e.g. the middle barrel 11) in one direction. For examples, the ratchet mechanism 12 may be configured to prohibit the relative rotation between the front barrel 2 and the main body barrel 3 in the opposite direction.

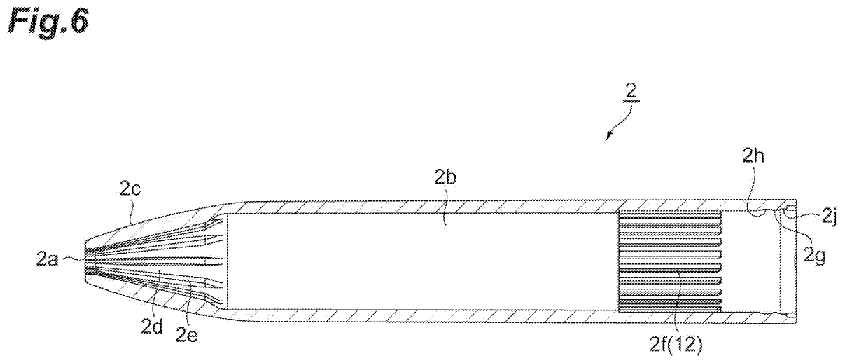

FIG. 6 is a longitudinal cross-sectional view of the front barrel 2. As illustrated in FIG. 6, the front barrel 2 may be formed of an ABS resin (i.e. a copolymer synthetic resin of Acrylonitrile Butadiene Styrene), may have a tubular shape. The front barrel 2 may include an opening 2a at the front end thereof. The opening 2a allows a front portion of the pipe member 1 to come out. Located inside the front barrel 2 is a storage area 2b for storing four cartridges 10, and any one of the four pipe members 1 provided in the storage area 2b is exposed forward from the opening 2a in response to the operation made by the user.

Located on a front side of an outer peripheral surface of the front barrel 2 is an inclined surface 2c that is gradually tapered forward. An inner peripheral surface 2d on the front side of the front barrel 2 is also tapered forward. Located on the inner peripheral surface 2d are ridges 2e configured to be engaged with the pipe member 1 in a rotational direction (i.e. a direction around the axis). In some examples, the ridges 2e are constituted by a number of raised portions arranged in the circumferential direction and extending in an inclination direction of the inner peripheral surface 2d. The ridges 2e extend across an entire area from one end to the other end in the inclination direction. Further, a space between the ridges 2e in the circumferential direction narrows toward the front side.

Located on a rear side of the inner peripheral surface of the front barrel 2, and provided as a component of the ratchet mechanism 12, is a raised and recessed portion 2f constituted by 24 raised and recessed portions arranged in the circumferential direction and extending in the axial direction by a predetermined length. Located behind the raised and recessed portion 2f on the inner peripheral surface of the front barrel 2 are an annular raised portion 2g configured to cause the middle barrel 11 to engage with a rear side of the front barrel 2 in the axial direction, an annular recessed portion 2h located in front of the annular raised portion 2g, and an annular recessed portion 2j located behind the annular raised portion 2g.

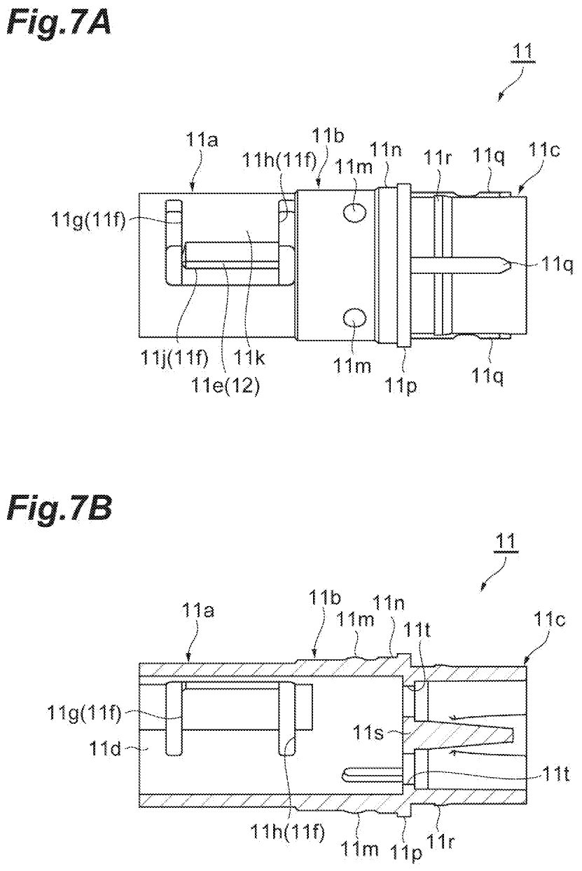

FIG. 7A is a side view of the middle barrel 11, and FIG. 7B is a longitudinal cross-sectional view of the middle barrel 11. The middle barrel 11 is an injection-molded product made of polyacetal (polyoxymethylene; POM) and has a stepped tubular outer shape. The middle barrel 11 includes a front barrel portion 11a, a central barrel portion 11b larger in outer diameter than the front barrel portion 11a, and a rear barrel portion 11c smaller in outer diameter than the front barrel portion 11a and the central barrel portion 11b, and arranged in this order from the front to the rear.

The front barrel portion 11a includes elastic or springy projections 11e that are located on opposite sides of the front barrel portion 11a from each other on an inner peripheral surface 11d and that constitute the other component of the ratchet mechanism 12. The elastic projection 11e may be configured to engage with the raised and recessed portion 2f of the front barrel 2 in the rotational direction and is provided in such a way as to project outward in the radial direction. Formed around the elastic projection 11e of the front barrel portion 11a is a cutout 11f that has a U-shape and that causes the inside and the outside of the middle barrel 11 to communicate with each other. The cutout 11f makes the elastic projection 11e springy in the radial direction. The elastic projection 11e of the middle barrel 11 may remain in continuous contact with the raised and recessed portion 2f of the front barrel 2.

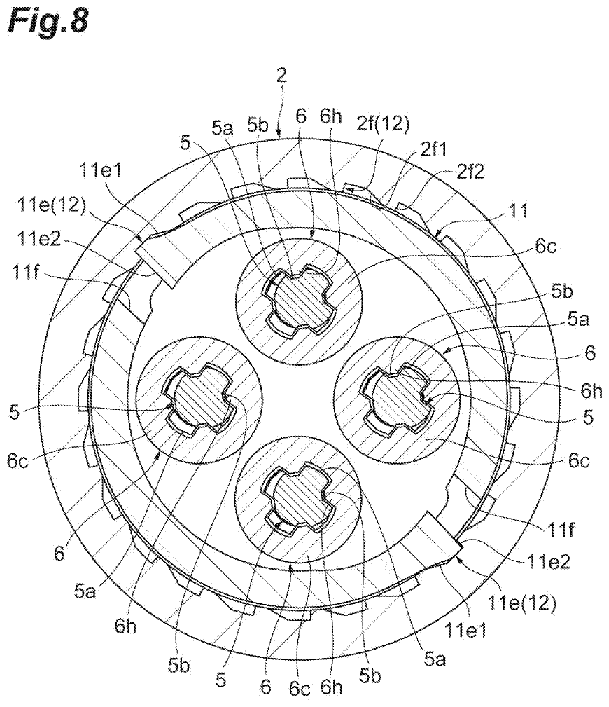

FIG. 8 is a cross-sectional view taken along line A-A of FIG. 1. As illustrated in FIG. 8, the raised and recessed portion 2f of the front barrel 2 constituting one component of the ratchet mechanism 12 includes an inclined surface 2fl inclined relative to the inner peripheral surface of the front barrel 2, and a side surface 2f2 formed substantially perpendicular to the inner peripheral surface of the front barrel 2. Further, the elastic projection 11e of the middle barrel 11 constituting the other component of the ratchet mechanism 12 includes an inclined surface 11e1 inclined relative to an outer peripheral surface of the middle barrel 11, and a side surface 11e2 formed substantially perpendicular to a tangent line to the outer peripheral surface of the middle barrel 11.

Referring again to FIG. 7A and FIG. 7B. The cutout 11f of the middle barrel 11 includes a pair of slits 11g and 11h made on both sides in the axial direction of the elastic projection 11e of the front barrel portion 11a and that extend in the circumferential direction. Additionally, the cutout 11f may include a slit 11j made on one side in the circumferential direction of the elastic projection 11e of the front barrel portion 11a and that extends contiguously to the slits 11g and 11h in the axial direction. One or more of the slits may comprise holes. A wall portion surrounded by the cutout 11f of the front barrel portion 11a serves as an arm 11k having flexibility in the radial direction. Accordingly, the elastic projection 11e disposed on an outer surface of an end of the arm 11k has springy force (e.g. energizing force or elastic force) in the radial direction.

Located on an outer peripheral surface of the central barrel portion 11b of the middle barrel 11 are a projection 11m configured to be detachably engaged with the annular raised portion 2g of the front barrel 2, an annular raised portion 11n configured to be inserted into the annular recessed portion 2j of the front barrel 2 from the rear, and a flange portion 11p located on the rear side of the annular raised portion 11n. A barrel portion of the middle barrel 11 located in front of the flange portion 11p is inserted into the front barrel 2 from the rear.

Formed on the rear barrel portion 11c of the middle barrel 11 is a ridge 11q configured to be engaged with the main body barrel 3 in the rotational direction and extending in the axial direction. The ridge 11q is formed at four positions equally distanced from each other in the circumferential direction on the outer peripheral surface of the rear barrel portion 11c. Located behind the flange portion 11p is a raised portion 11r configured to be engaged with the main body barrel 3 in the axial direction and extending in the circumferential direction between the ridges 11q.

As illustrated in FIG. 7B, the middle barrel 11 is partitioned by a holder accommodating portion 11s through which the four sliders 8 are inserted in the axial direction on the inner surface side of the flange portion 11p. Located at each of four positions equally distanced from each other in the circumferential direction of the holder accommodating portion 11s is an opening lit that has a circular shape and that allows the slider 8 to be inserted therethrough in the axial direction.

The front barrel portion 11a and the central barrel portion 11b of the middle barrel 11 are inserted into the front barrel 2 from the rear side. In this configuration, the elastic projection 11e of the front barrel portion 11a is engaged with the raised and recessed portion 2f of the front barrel 2 in the rotational direction, the projection 11m of the central barrel portion 11b is engaged with the annular raised portion 2g of the front barrel 2 and then fitted into the annular recessed portion 2h, and then the annular raised portion 11n of the central barrel portion 11b enters the annular recessed portion 2j of the front barrel 2.

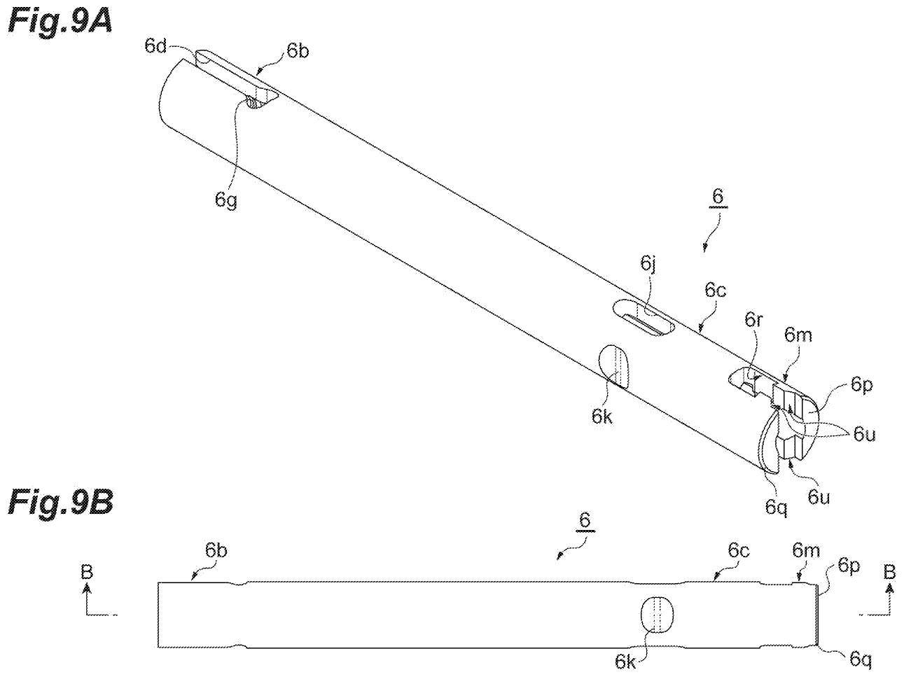

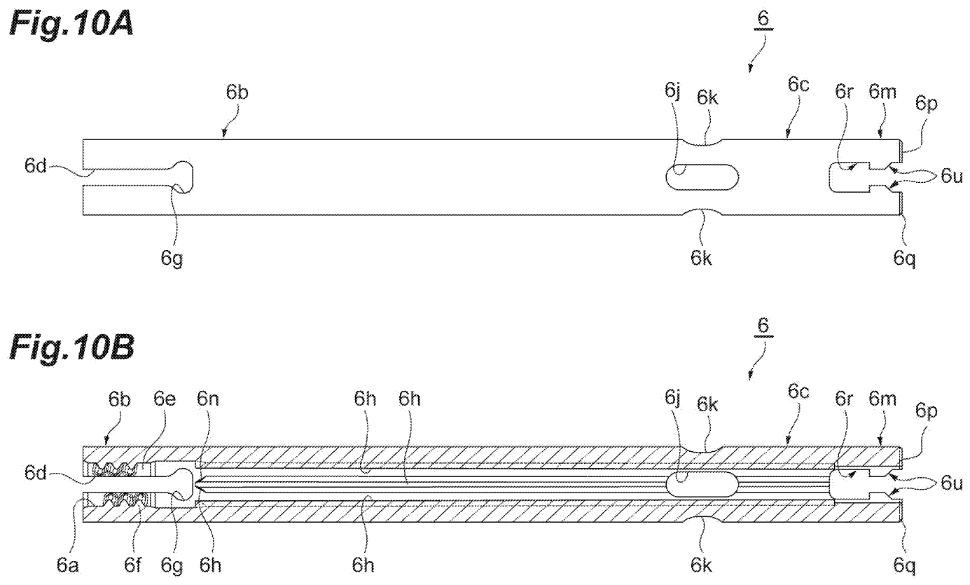

FIG. 9A is a perspective view of the holder 6, and FIG. 9B is a side view of the holder 6. FIG. 10A is a side view of the holder 6 as viewed from a direction different from the direction of FIG. 9B, and FIG. 10B is a cross-sectional view taken along line B-B of FIG. 9B. The holder 6 has a tubular shape as a whole. An example material of the holder 6 includes POM (polyoxymethylene). The holder 6 includes a mobile body pressing portion 6b configured to press the mobile body 5, and a tubular portion 6c that has a tubular shape and extends rearward from the mobile body pressing portion 6b. The mobile body pressing portion 6b includes a hole 6a provided on the front side of the holder 6 for accommodating the mobile body 5.

The mobile body pressing portion 6b of the holder 6 includes a pair of slits 6d that extend rearward from a front end thereof by a predetermined length and that oppose each other in the mobile body pressing portion 6b. In the mobile body pressing portion 6b including the slits 6d, the mobile body 5 is tightened inward in the radial direction by elasticity of the resin of the holder 6. The slits 6d allow the mobile body pressing portion 6b to be increased in diameter.

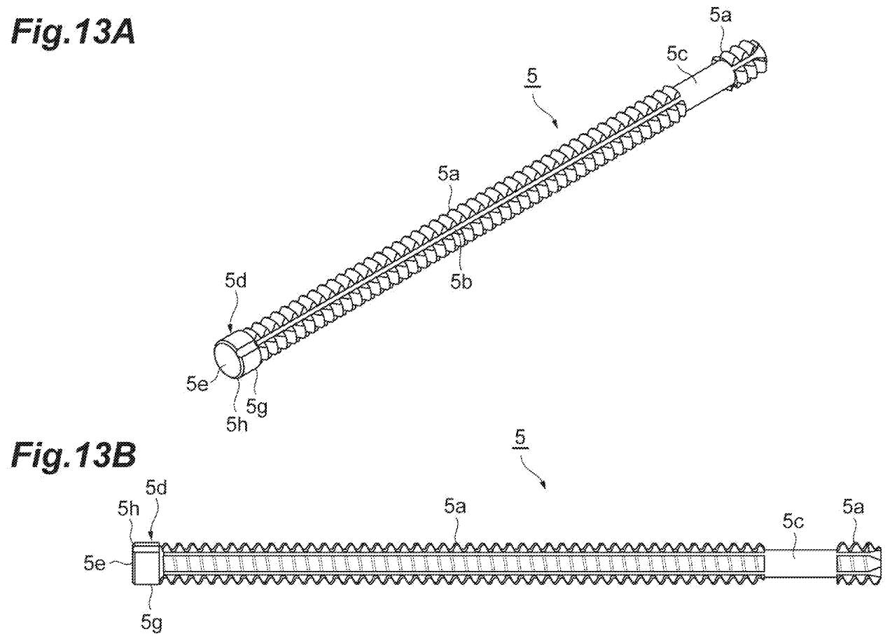

Located at a rear end of each of the slits 6d is an expanded portion 6g which appears to expand when viewed from the radial direction. The elasticity of the mobile body pressing portion 6b for tightening the mobile body 5 may be selectively adjusted by the expanded portion 6g. Located on an inner surface 6e of the mobile body pressing portion 6b is a projection 6f having a spiral shape. The projection 6f is disposed at three positions in the axial direction on the inner surface 6e of the holder 6. The projection 6f comes into contact with a male thread 5a (see FIGS. 13A and 13B) of the mobile body 5 from the outer side in the radial direction. Further, the mobile body 5 may be configured to be engaged with and/or to be detachably held in the holder 6, via the projection 6f.

Located in the tubular portion 6c of the holder 6 are four ridges 6h arranged at four positions equally distanced from each other in the circumferential direction and extending in the axial direction. The ridges 6h may be configured to prevent the mobile body 5 from rotating relative to the holder 6. Each of the ridges 6h includes a tapered surface 6n tapered toward the front end thereof, and. Due to the tapered surface 6n, the ridge 6h has a shape that allows the mobile body 5 to be readily inserted from the front side.

In a cross-sectional view of the tubular portion 6c taken along a plane orthogonal to the axial direction, an internal space of the tubular portion 6c has a noncircular shape (e.g. cross shape) due to the ridges 6h (see FIG. 8). Located in the tubular portion 6c, as a support portion that supports a core pin in such a way as to prevent the core pin from being tilted by pressure generated at injection molding, is a through hole 6j that has an elliptic shape, extends in the axial direction, and passes through the holder 6 from the inside to the outside.

Through holes 6j are formed on opposite sides of the tubular portion 6c from each other in the radial direction in the tubular portion 6c. The through hole 6j is provided on the rear side of the tubular portion 6c and at the same position as the slit 6d is located as viewed from the axial direction. A recessed portion 6k is recessed inward in the radial direction from the outer peripheral surface of the tubular portion 6c. The recessed portion 6k is a gate mark generated in the injection molding and has a circular shape extending in the circumferential direction. Recessed portions 6k are located on opposite sides of the tubular portion 6c from each other in the radial direction and are located between a pair of the through holes 6j.

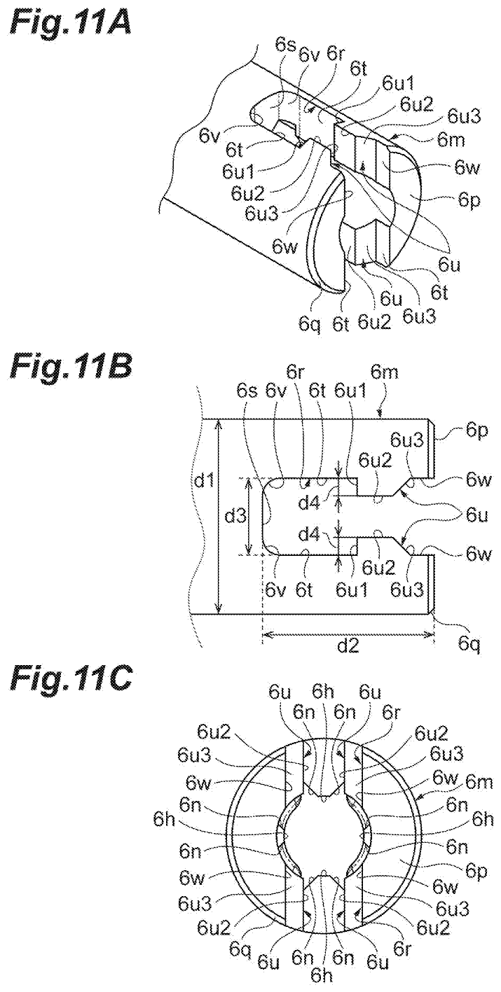

FIG. 11A is an enlarged perspective view of a rear end of the holder 6, FIG. 11B is a side view of the rear end of the holder 6, and FIG. 11C is a rear view of the holder 6 as viewed from the rear end of the holder 6. Located at the rear end of the holder 6 is a tubular portion 6m (first engagement portion) that has a tubular shape and extends contiguously from the tubular portion 6c to the rear end of the holder 6 in the axial direction. An outer diameter d1 of the tubular portion 6m is, for example, 3.3 mm.

The tubular portion 6m includes a rear end surface 6p located at the rear end of the holder 6, and an inclined surface 6q formed along a periphery of the rear end surface 6p and inclined forward from the rear end surface 6p. The rear end surface 6p is a flat surface extending in the radial direction and the circumferential direction. The inclined surface 6q is inclined outward in the radial direction while extending forward. Located in the tubular portion 6m is a slit 6r (cutout hole) extending by a predetermined length forward from the rear end surface 6p.

Slits 6r are formed at opposite sides of the tubular portion 6m in the radial direction. The slit 6r is provided, for example, at the same position as the slit 6d and the through hole 6j are located as viewed from the axial direction. The slit 6r thus formed allows the tubular portion 6m to be expanded outward (flared) in the radial direction. The slit 6r has a rectangular shape extending in the axial direction.

The slit 6r includes an inner wall surface 6s located at the front end thereof, and a pair of inner wall surfaces 6t provided behind the inner wall surface 6s and located on opposite sides from each other in the circumferential direction. Additionally, the slit 6r includes a pair of raised portions 6u each projecting from a rear side of a corresponding one of the pair of inner wall surfaces 6t in the circumferential direction, and a pair of inner wall surfaces 6w each provided between a corresponding one of the pair of raised portions 6u and the rear end surface 6p. The inner wall surface 6s extends in the radial direction and the circumferential direction, for example, along the rear end surface 6p. A distance d2 between the inner wall surface 6s and the rear end surface 6p in the axial direction (i.e. a length of the slit 6r in the axial direction) is, for example, 2.9 mm. The distance d2 is in a range of, for example, 70% to 120% of the outer diameter d1 of the tubular portion 6m.

Each of the pair of inner wall surfaces 6t extends in the axial direction and the radial direction. Each of the pair of inner wall surfaces 6t is substantially perpendicular to the inner wall surface 6s and the rear end surface 6p. A distance d3 between the pair of inner wall surfaces 6t (i.e. a width of the slit 6r) is, for example, 1.3 mm. The distance d3 is in a range of, for example, 20% to 60% of the outer diameter d1 of the tubular portion 6m. Located at a connecting portion between each of the inner wall surfaces 6t and the inner wall surface 6s, that is, at each corner portion of the front end of the slit 6r, is a curved surface 6v extending in a curved form in the axial direction and the circumferential direction. The curved surface 6v may be configured to reduce concentration of stress on a corresponding corner of the slit 6r when the tubular portion 6m is expanded.

The pair of inner wall surfaces 6w oppose each other in the circumferential direction. Each of the inner wall surfaces 6w extends along a corresponding one of the inner wall surfaces 6t. A distance between the pair of inner wall surfaces 6w is, for example, the same as a distance between the pair of inner wall surfaces 6t, and each of the inner wall surfaces 6w may be located at the same position as a corresponding one of the inner wall surfaces 6t, when viewed from the axial direction. The pair of raised portions 6u are provided on the rear side of the slit 6r. The raised portions 6u are located on opposite sides from each other in the circumferential direction and symmetrical in the circumferential direction. Each of the raised portions 6u has a rectangular shape as viewed from the radial direction.

Each of the raised portions 6u includes a front end surface 6u1 located at the front end thereof, a top surface 6u2 extending rearward from the front end surface 6u1, and a tapered surface 6u3 contiguously extending to the top surface 6u2 and the inner wall surface 6w and inclined relative to the top surface 6u2 and the inner wall surface 6w. The front end surface 6u1 is a flat surface along the radial direction and the circumferential direction and is formed substantially perpendicular to the inner wall surface 6t. The front end surface 6u1 and the inner wall surface 6s oppose each other in the axial direction and are separated from each other by a predetermined distance.

The top surface 6u2 is located closer to a center of the slit 6r than the inner wall surface 6t, in a width direction of the slit 6r. The top surface 6u2 extends along the inner wall surface 6t, and in some examples, extends parallel to the inner wall surface 6t. The top surface 6u2 is formed substantially perpendicular to the front end surface 6u1. A distance d4 between the top surface 6u2 and the inner wall surface 6t (i.e. a height of the raised portion 6u from the inner wall surface 6t) is, for example, 0.3 mm. The distance d4 is in a range of, for example, 5% to 20% of the outer diameter d1 of the tubular portion 6m.

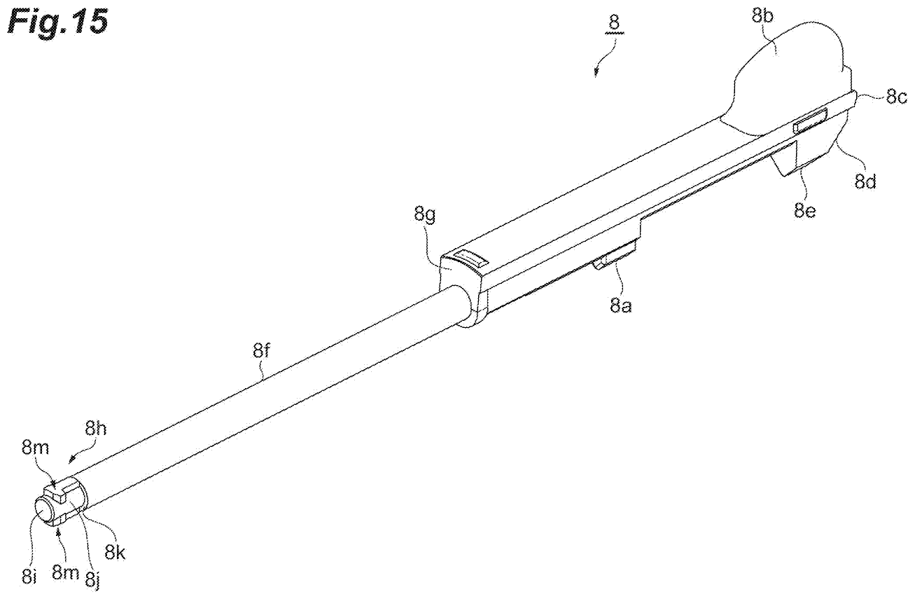

The tapered surface 6u3 is inclined in such a way as to be flared rearward. In some examples, the pair of tapered surfaces 6u3 are inclined rearward in such a way as to spread apart from each other. The projection 8m (see FIG. 15) of the slider 8 (to be described later) may be readily inserted into the slit 6r from the rear due to the tapered surface 6u3 of the slit 6r.

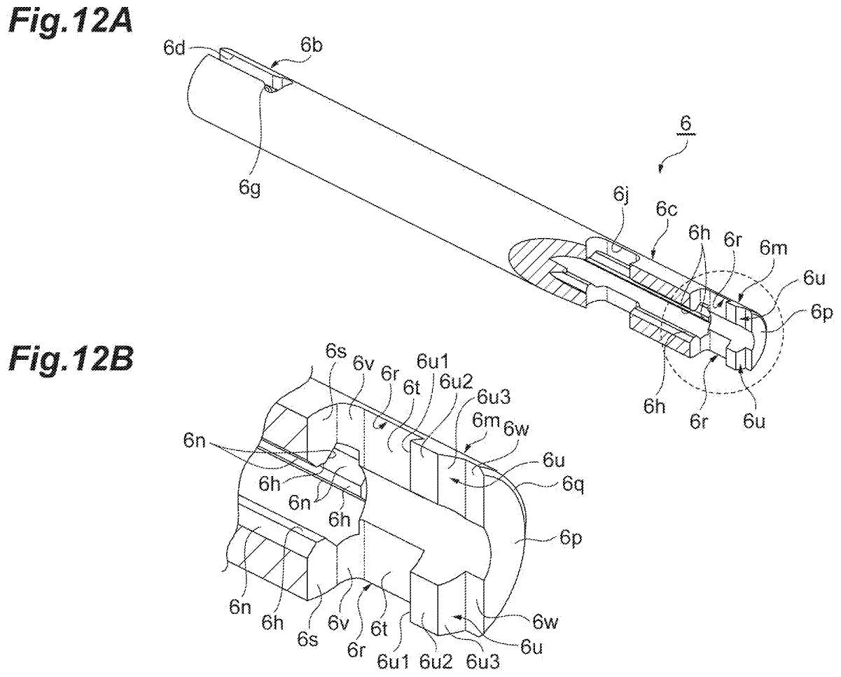

FIG. 12A is a perspective, partial cross-sectional view of the holder 6, and FIG. 12B is a perspective, partial cross-sectional view of the holder 6, illustrating the portion around the rear end of the holder 6 in an enlarged manner. The pair of slits 6r are provided symmetrically about the axis of the tubular portion 6m. Further, the ridges 6h provided in the tubular portion 6c extend to the front end of the tubular portion 6m, that is, to a boundary between the tubular portion 6c and the tubular portion 6m. In some examples, the ridges 6h are not provided in the tubular portion 6m.

FIG. 13A is a perspective view of the mobile body 5, and FIG. 13B is a side view of the mobile body 5. The mobile body 5 has a rod-like outer shape. An example material of the mobile body 5 includes POM. The mobile body 5 includes the male thread 5a and four groove portions 5b extending in the axial direction on the outer peripheral surface of mobile body 5. The groove portions 5b are provided at four positions equally distanced from each other in the circumferential direction.

The mobile body 5 includes, on a rear side surface thereof, a curved surface portion 5c on which no male thread 5a is formed. The curved surface portion 5c may be configured to cause the mobile body 5 to be idle rotation when the mobile body 5 reaches a forward limit. Further, the male thread 5a located behind the curved surface portion 5c may be configured to prevent the mobile body 5 from falling off from the holder 6 with the mobile body 5 inserted into the rear side of the projection 6f when assembled to the holder 6 (see FIG. 3). The male thread 5a is formed throughout the mobile body 5 in the axial direction. For example, the male thread 5a may be formed wholly in the axial direction. In other examples, there may be a portion where no male thread 5a is formed, such as where the curved surface portion 5c is formed in the middle in the axial direction.

The four groove portions 5b of the mobile body 5 may be configured to be fitted into the ridges 6h of the holder 6 (see FIG. 8). Additionally, the groove portions 5b may be configured to cause the mobile body 5 and the holder 6 to rotate synchronously. The groove portions 5b cause a cross-section of the male thread 5a and the groove portions 5b taken along a plane orthogonal to the axial direction to have a noncircular shape (e.g. cross shape) corresponding to the internal space of the tubular portion 6c of the holder 6.

A pitch of the male thread 5a of the mobile body 5 (i.e. a distance between crests of the male thread 5a in the axial direction) is, for example, between 0.3 mm and 1.0 mm or less. In some examples, the pitch may be approximately 0.6 mm.

The male thread 5a and the groove portions 5b of the mobile body 5 are inserted into the holder 6 from the front so that the groove portions 5b has a clearance with respect to the ridges 6h. Then, the projection 6f provided on the inner surface 6e of the holder 6 is engaged with the male thread 5a of the mobile body 5 to cause the holder 6 to hold the mobile body 5. The projection 6f presses the male thread 5a from the outer side in the radial direction, thereby increasing a holding force of the holder 6 with respect to the mobile body 5.

Located at the front end of the mobile body 5 is a push-out portion 5d that has a columnar shape and is configured to push out the drawing material M in the pipe member 1 in a forward direction. The push-out portion 5d includes a bottom surface 5e located at the front end thereof, a side surface 5g extending in the circumferential direction, and a tapered surface 5h inclined relative to the bottom surface 5e and contiguously extending to the bottom surface 5e and the side surface 5g. The bottom surface 5e may be configured to push out the drawing material M in the forward direction.

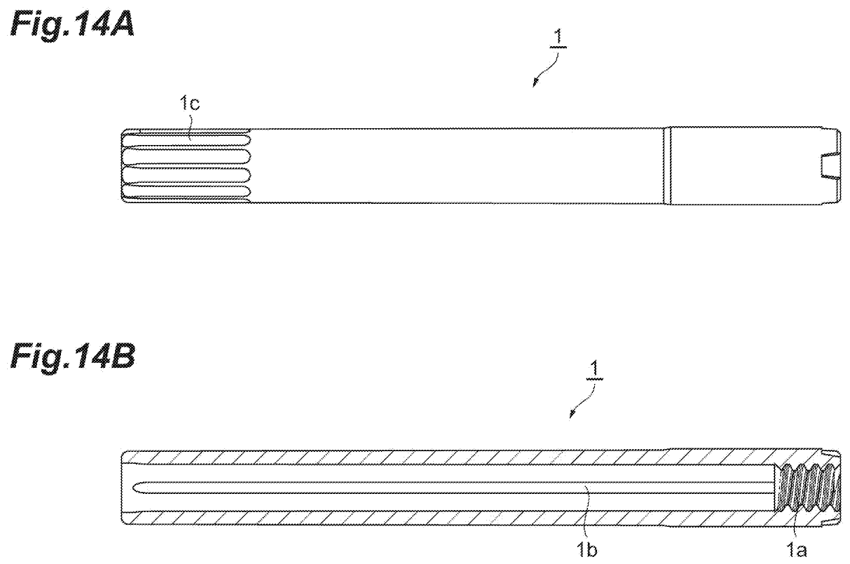

FIG. 14A is a side view of the pipe member 1, and FIG. 14B is a longitudinal cross-sectional view of the pipe member 1. The pipe member 1 has a substantially tubular shape. An example material of the pipe member 1 includes polypropylene (PP). The pipe member 1 may be colored the same color as the drawing material M or may be made of a transparent material to facilitate the identification of the color of the drawing material M. Located on a rear side of an inner peripheral surface of the pipe member 1 is a female thread 1a configured to move the mobile body 5 in the axial direction. In some examples, the pitch of the female thread 1a of the pipe member 1 (a distance between crests of the female thread 1a in the axial direction) may be approximately the same as the male thread 5a of the mobile body 5.

Located in front of the female thread 1a on the inner surface of the pipe member 1 are ridges 1b extending in the axial direction and arranged at four positions equally distanced from each other in the circumferential direction. The ridges 1b may be configured to prevent the drawing material M loaded in the pipe member 1 from coming off. While various examples may include a different number of ridges 1b, in an example including four ridges 1b the drawing material M can be readily prevented from coming off. Located on a front side of an outer peripheral surface of the pipe member 1 are recessed grooves 1c configured to be engaged with the ridges 2e of the front barrel 2 in the rotational direction. In some examples, the recessed grooves 1c include a plurality of recessed portions arranged in the circumferential direction and extending by a predetermined length in the axial direction.

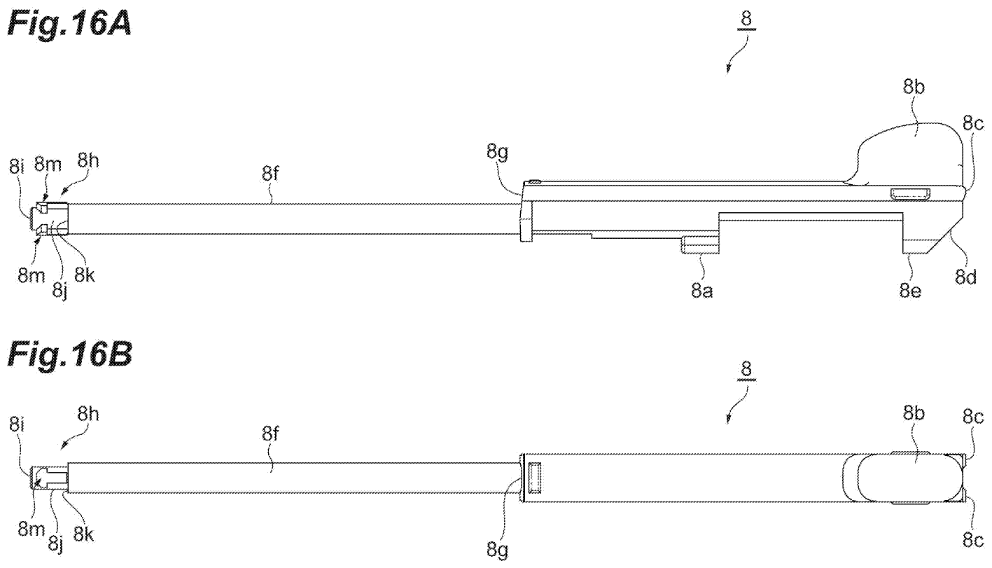

FIG. 15 is a perspective view of the slider 8. FIG. 16A is a side view of the slider 8, and FIG. 16B is a side view of the slider 8 as viewed from a direction different from the direction of FIG. 16A. An example material of the slider 8 includes POM resin. A color of the slider 8 is, for example, the same as the color of a corresponding drawing material M. Sliding the slider 8 having a particular color forward by a fixed amount exposes the drawing material M having the particular color from the opening 2a of the front barrel 2 (see FIG. 5).

The slider 8 has a shape extending in the axial direction. Located on a rear side of the slider 8 is a projection portion 8a configured to cause another slider 8 to be pulled back. The projection portion 8a projects inward in the radial direction in the main body barrel 3 and extends in the axial direction (see FIG. 3). Located at a rear end of the slider 8 are a projection portion 8b projecting outward in the radial direction from the main body barrel 3, and a rear end portion 8c projecting rearward at the rear end of the slider 8 and configured to be caught in the main body barrel 3. Additionally, a projection portion 8e projecting inward in the radial direction of the main body barrel 3, and having an inclined surface 8d with which the projection portion 8a of another slider 8 comes into contact, may be located at the rear end of the slider 8.

Located on a front side of the slider 8 is a rod portion 8f having a round rod shape and around which the spring 9 is wound (see FIG. 4 and FIG. 5). Additionally, located at a rear end of the rod portion 8f is a surface 8g having a flat shape and projecting outward in the radial direction from the rod portion 8f. The rod portion 8f is inserted into the opening 11t (see FIG. 7B) of the holder accommodating portion 11s of the middle barrel 11 in the axial direction. Further, one end of the spring 9 is in contact with the surface 8g. In some examples, the slider 8 includes the rod portion 8f provided on the front side thereof and the surface 8g projecting outward in the radial direction at the rear end of the rod portion 8f to allow the spring 9 to be readily mounted.

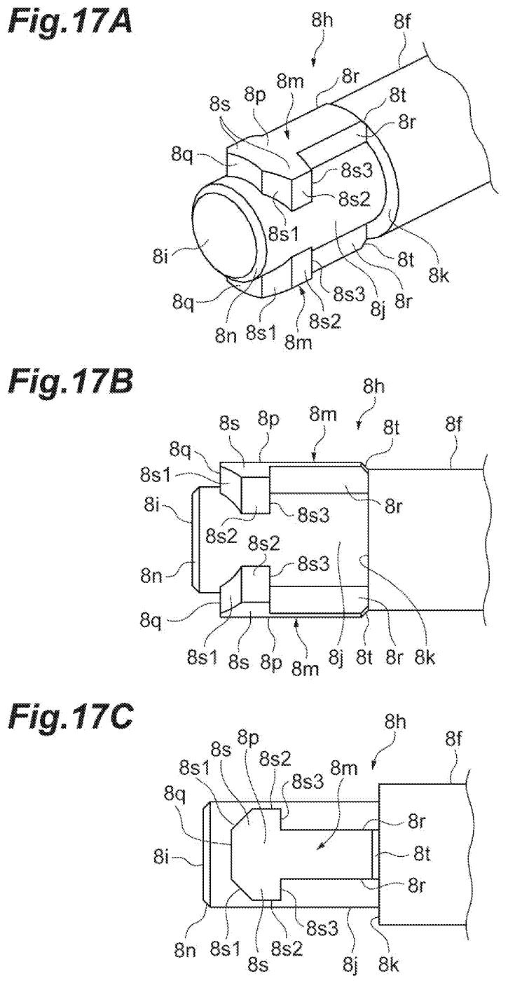

FIG. 17A is an enlarged perspective view of a front end of the slider 8, FIG. 17B is a side view of the front end of the slider 8, and FIG. 17C is a side view of the front end of the slider 8 as viewed from a direction different from the direction of FIG. 17B. Located at the front end of the slider 8 is an insertion portion 8h (second engagement portion) configured to be inserted into the tubular portion 6m of the holder 6 from the rear and to be engaged with the tubular portion 6m in the axial direction. The insertion portion 8h projects forward from the front end of the rod portion 8f and has a generally cylindrical shape.

The insertion portion 8h includes a front end surface 8i located at the front end thereof, and an outer peripheral surface 8j having a cylindrical surface shape and extending rearward from the front end surface 8i. Additionally, the insertion portion 8h may include a surface 8k projecting outward in the radial direction from the rear end of the outer peripheral surface 8j, and the projection 8m projecting outward in the radial direction from the outer peripheral surface 8j. The front end surface 8i is a flat surface along the radial direction and the circumferential direction. Located on a periphery of the front end surface 8i is an inclined surface 8n inclined outward in the radial direction while extending rearward from the front end surface 8i. The insertion portion 8h may be configured to be readily inserted into the tubular portion 6m from the rear due to the inclined surface 8n.

The outer peripheral surface 8j is smaller in outer diameter than the rod portion 8f. Further, the outer diameter of the outer peripheral surface 8j may be the same as or slightly smaller than the inner diameter of the tubular portion 6m. The surface 8k is a flat surface that is oriented along the radial direction and the circumferential direction and that extends in the radial direction between the outer peripheral surface 8j and an outer peripheral surface of the rod portion 8f. Projections 8m are located on opposite sides from each other in the radial direction on the outer peripheral surface 8j, the positions of the projections 8m corresponding to the positions where the slits 6r are located. The projection 8m and the slit 6r are both provided at each of the opposite sides from each other in the radial direction (i.e., at two positions located equidistant from each other in the circumferential direction).

The projection 8m is inserted into the slit 6r from the rear and is engaged with the slit 6r in the axial direction. The projection 8m has a T-shape extending in the axial direction and having an expanded front side, as viewed from the radial direction. A front end of the projection 8m is located behind the front end surface 8i, and a rear end of the projection 8m is connected to the surface 8k. The projection 8m includes a top surface 8p located outward in the radial direction of the outer peripheral surface 8j, and a front end surface 8q located at the front end of the projection 8m. Additionally, the projection 8m may include a pair of side surfaces 8r extending rearward of the front end surface 8q, and a pair of raised portions 8s provided between the front end surface 8q and the pair of side surfaces 8r.

The top surface 8p is formed in a curved shape along the axial direction and the circumferential direction, and is located outward in the radial direction of the outer peripheral surface of the rod portion 8f. In some examples, the curvatures of the pair of top surfaces 8p located on opposite sides of the insertion portion 8h from each other in the radial direction may be identical to each other. A distance between the pair of top surfaces 8p (i.e. a maximum dimension in the radial direction of the insertion portion 8h) is smaller than the outer diameter d1 of the tubular portion 6m (see FIG. 11B). Located at the rear end of the top surface 8p is an inclined surface 8t inclined inward in the radial direction while extending rearward. The inclined surface 8t continuously extends to the outer peripheral surface of the rod portion 8f.

The front end surface 8q is provided between the top surface 8p and the outer peripheral surface 8j. The front end surface 8q is a flat surface along the front end surface 8i and is formed substantially perpendicular to the outer peripheral surface 8j. The pair of side surfaces 8r of each of the projections 8m are located on opposite sides of the insertion portion 8h from each other in the circumferential direction. Each of the side surfaces 8r is formed extending from the surface 8k toward the front end surface 8q and substantially perpendicular to the surface 8k and the front end surface 8q.

Each of the pair of raised portions 8s of each of the projections 8m projects from the front end of a corresponding one of the side surfaces 8r in the circumferential direction and has a rectangular shape as viewed from the radial direction. The raised portions 8s are provided symmetrically about a reference plane passing through the axis and a center of a width of the projection 8m. Each of the raised portions 8s includes a tapered surface 8s1 provided on the front side thereof, a top surface 8s2 extending rearward from the tapered surface 8s1, and a rear end surface 8s3 extending contiguously to the top surface 8s2 and the side surface 8r and serving as a rear end of the raised portion 8s.

The tapered surface 8s1 is inclined so as to be tapered toward the front end surface 8q. In some examples, the pair of tapered surfaces 8s1 located on opposite sides of the raised portion 8s from each other are inclined so as to be closer to each other toward the front end surface 8q. The tapered surface 8s1 extends along the tapered surface 6u3 of the raised portion 6u of the slit 6r, and in some examples, extends parallel to the tapered surface 6u3. The projection 8m is shaped so as to be readily inserted into the slit 6r from the rear due to the tapered surface 8s1.

The top surface 8s2 is located on a side apart from the center of the width of the projection 8m as compared with the side surface 8r. The top surface 8s2 extends along the side surface 8r, and in some examples, extends parallel to the side surface 8r. The rear end surface 8s3 is a flat surface along the front end surface 8q, and in some examples, extends parallel to the front end surface 8q. The rear end surface 8s3 is formed substantially perpendicular to the top surface 8s2 and the side surface 8r.

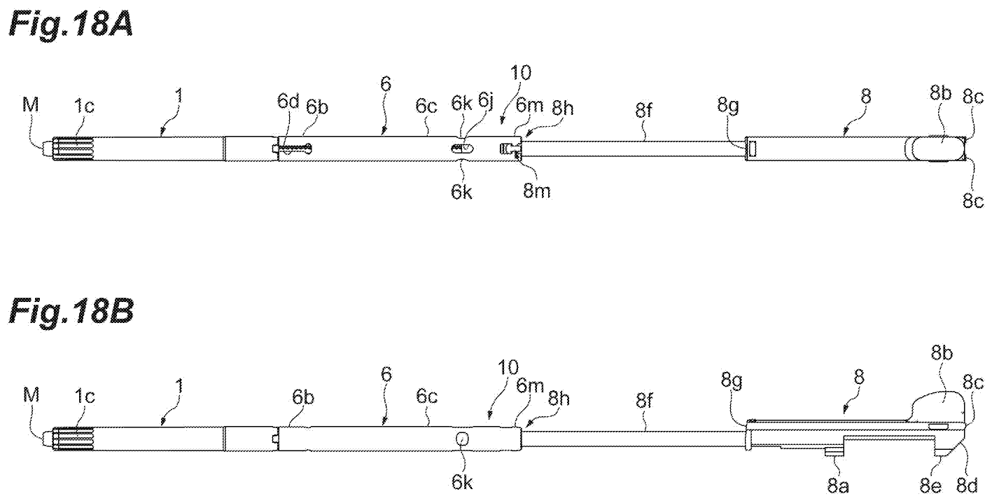

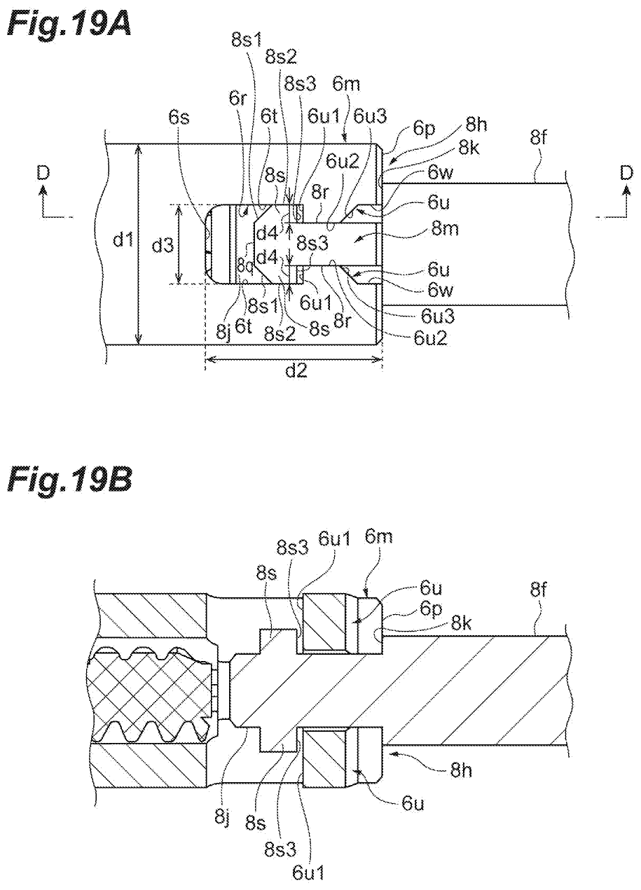

The insertion portion 8h of the slider 8 may be inserted into the tubular portion 6m of the holder 6 in the axial direction and then engaged with the tubular portion 6m in the axial direction. FIG. 18A is a side view of the slider 8 and the cartridge 10, and FIG. 18B is a side view of the slider 8 and the cartridge 10 as viewed from a direction different from the direction of FIG. 18A. FIG. 19A is an enlarged side view of main portions of the slider 8 and the cartridge 10, and FIG. 19B is a cross-sectional view taken along line D-D of FIG. 19A.

When the insertion portion 8h is inserted into the tubular portion 6m, the projection 8m of the insertion portion 8h is inserted into the slit 6r of the tubular portion 6m from the rear. Each of the raised portions 8s of the projection 8m enters a space in front of a corresponding one of the raised portions 6u of the slit 6r, is caught in the raised portion 6u, and then is engaged with the raised portion 6u in the axial direction. In some examples, the rear end surface 8s3 of each of the raised portions 8s and the front end surface 6u1 of a corresponding one of the raised portions 6u oppose each other in the axial direction. Accordingly, when the cartridge 10 including the holder 6 is pulled forward, the front end surface 6u1 of each of the raised portions 6u comes into contact with the rear end surface 8s3 of a corresponding one of the raised portions 8s. The contact between the front end surface 6u1 and the rear end surface 8s3 restricts forward movement of the cartridge 10 relative to the slider 8.

As shown in FIG. 19A, the outer peripheral surface 8j of the insertion portion 8h may be configured to oppose the inner peripheral surface of the tubular portion 6m, and the surface 8k of the insertion portion 8h may be configured to oppose the rear end surface 6p of the tubular portion 6m during one or more modes of operation. When the surface 8k opposes the rear end surface 6p, the cartridge 10 is pushed rearward, the rear end surface 6p comes into contact with the surface 8k. The contact between the rear end surface 6p and the surface 8k restricts rearward movement of the cartridge 10 relative to the slider 8.

In some examples, the pair of inner wall surfaces 6t of the slit 6r may be configured to be in contact with the top surfaces 8s2 of the pair of raised portions 8s. The distance d3 between the pair of inner wall surfaces 6t is the same as a distance between the pair of top surfaces 8s2. The top surfaces 6u2 of the pair of raised portions 6u are in contact with the pair of side surfaces 8r of the projection 8m. The distance d4 between the top surface 6u2 and the inner wall surface 6t is the same as the distance between the top surface 8s2 and the side surface 8r (i.e. a height of the raised portion 8s from the side surface 8r).

The inner wall surface 6t and the top surface 6u2 come into contact with the top surface 8s2 and the side surface 8r, respectively, thereby causing the cartridge 10 to engage with the slider 8 in the rotational direction. In some examples, the front end surface 8q of the projection 8m is located apart from the inner wall surface 6s of the slit 6r by a predetermined distance to absorb an assembly tolerance and the like when the projection 8m is engaged with the slit 6r in the axial direction.

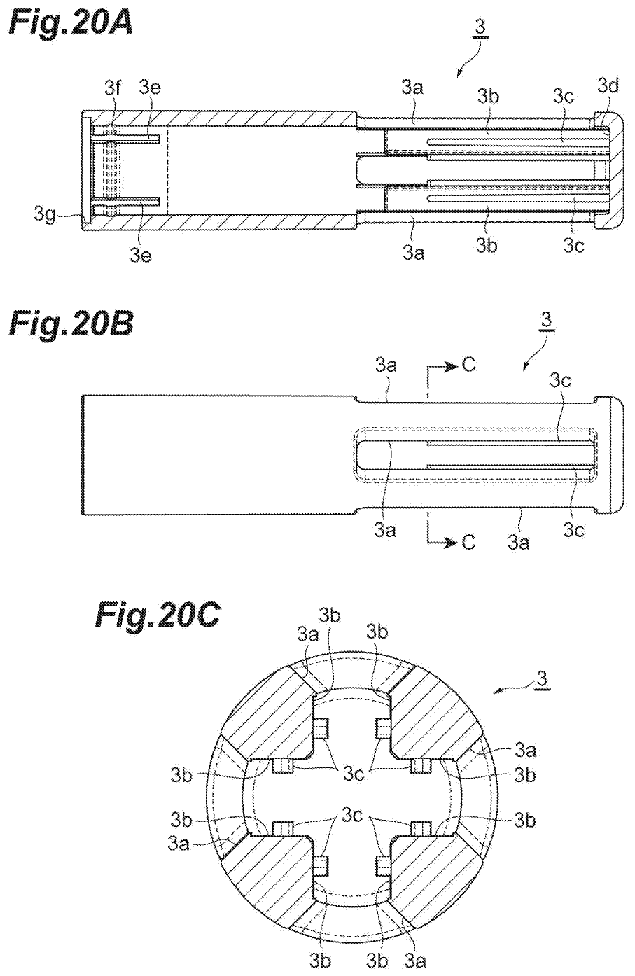

FIG. 20A is a longitudinal cross-sectional view of the main body barrel 3, FIG. 20B is a side view of the main body barrel 3, and FIG. 20C is a cross-sectional view taken along line C-C of FIG. 20B. The main body barrel 3 is an injection-molded product made of ABS resin, and has a bottomed tubular shape. Located on a rear side of the main body barrel 3 is a cutout portion 3a extending in the axial direction and allowing the projection portion 8b of the slider 8 to project outward. The cutout portion 3a may be provided at four positions equally distanced from each other in the circumferential direction.

Located on an inner side in the radial direction of the cutout portion 3a in the main body barrel 3 are a flat portion 3b extending inward in the radial direction from the cutout portion 3a, and a projection portion 3c extending in the axial direction on the flat portion 3b. A rear side of the projection portion 3c extends to a bottom surface 3d of the main body barrel 3. When the projection portion 8b of the slider 8 is moved forward along the cutout portion 3a of the main body barrel 3, the rear end portion 8c of the slider 8 is moved forward along the projection portion 3c (see FIG. 5).

When the rear end portion 8c reaches the front end of the projection portion 3c, the rear end portion 8c enters inward of the cutout portion 3a in the radial direction and is then caught in the front end of the projection portion 3c. When the rear end portion 8c of one slider 8 is caught in the front end of the projection portion 3c, the projection portion 8a of another slider 8 is close to the inclined surface 8d of the one slider 8.

With reference to FIG. 20A, located on the front side of the inner peripheral surface of the main body barrel 3 are a recessed groove 3e configured to be engaged with the ridge 11q of the middle barrel 11 in the rotational direction, and an annular recessed portion 3f configured to be engaged with the raised portion 11r of the middle barrel 11 in the axial direction. Additionally, an annular recessed portion 3g where the flange portion 11p of the middle barrel 11 enters from the front may be located on the front side of the inner peripheral surface of the main body barrel 3. The recessed groove 3e extends rearward from the annular recessed portion 3g located at the front end of the main body barrel 3 by a predetermined length. Each of the recessed grooves 3e is disposed on the inner peripheral surface of the main body barrel 3 at four positions equally distanced from each other in the circumferential direction. Further, the annular recessed portion 3f extends in the circumferential direction between the recessed grooves 3e.

The four sliders 8 are inserted into the main body barrel 3 from the front side of the main body barrel 3, and the projection portions 8b of the sliders 8 project outward from the cutout portions 3a. The middle barrel 11 enters the front end of the main body barrel 3. When the middle barrel 11 enters the main body barrel 3, the ridge 11q of the middle barrel 11 enters the recessed groove 3e of the main body barrel 3, and the raised portion 11r of the middle barrel 11 is engaged with the annular recessed portion 3f of the main body barrel 3 in the axial direction. Additionally, the flange portion 11p of the middle barrel 11 enters the annular recessed portion 3g, thereby causing the middle barrel 11 to engage with the main body barrel 3 in such a way as to be synchronously rotatable.

As illustrated in FIG. 4 and FIG. 5, the spring 9 (e.g. springs 9A to 9C) is wound around the rod portion 8f of the slider 8 with a clearance provided with respect to the outer periphery of the rod portion 8f. The front end of the spring 9 is in contact with the rear wall of the holder accommodating portion 11s in the middle barrel 11, and the rear end of the spring 9 is in contact with the surface 8g located near the center of the slider 8 in the axial direction. This causes the spring 9 to energize the slider 8 rearward.

An example operation using the feeding pencil 100 is described below. In the feeding pencil 100 in an initial state illustrated in FIG. 4, the four sliders 8 are each located at the rear end of a corresponding one of the cutout portions 3a of the main body barrel 3, and the four pipe members 1 are located inside the front barrel 2. In this state, when the slider 8A is moved forward along the cutout portion 3a by a fixed amount, as illustrated in FIG. 5, the cartridge 10A engaged with the slider 8A in the axial direction is moved forward, and the drawing material M1 is exposed to the front from the opening 2a of the front barrel 2.

When the front side portion of the pipe member 1A enters the inner peripheral surface 2d of the front barrel 2, the rod portion 8f of the slider 8A is deformed in such a way as to curve in the axial direction, and the recessed groove 1c of the pipe member 1A is engaged with the ridges 2e of the front barrel 2 in the rotational direction. Then, the rear end portion 8c of the slider 8A enters inward in the radial direction at the front end of the projection portion 3c of the main body barrel 3.

In some examples, when the user rotates the main body barrel 3 relative to the front barrel 2 in one direction (e.g. clockwise), the middle barrel 11, the four sliders 8, the four holders 6, and the four mobile bodies 5 start to rotate in the one direction. The pipe members 1B to 1D whose recessed grooves 1c are not engaged with the ridges 2e of the front barrel 2 rotate in response to the relative rotation in the one direction.

In some examples, the holder 6A connected using the mobile body 5A to the pipe member 1A whose recessed groove 1c is engaged with the ridges 2e of the front barrel 2 starts to rotate in a first direction in response to the relative rotation in the first direction. The pipe member 1A whose recessed groove 1c is engaged with the ridges 2e of the front barrel 2 may not rotate synchronously with the rotation of the mobile body 5A in the first direction, and the mobile body 5A rotates relative to the pipe member 1A. Accordingly, the relative rotation in the first direction causes the male thread 5a of the mobile body 5 and the female thread 1a of the pipe member 1 to engage with each other, thereby causing the mobile body 5A to start to move forward relative to the pipe member 1A. Then, the bottom surface 5e of the push-out portion 5d of the mobile body 5A pushes out the drawing material M1 loaded in the pipe member 1A forward, thereby causing both the mobile body 5A and the drawing material M1 to start to move forward relative to the pipe member 1A.

During the relative rotation in the first direction, as illustrated in FIG. 8, the elastic projection 11e of the middle barrel 11 constituting part of the ratchet mechanism 12 is engaged with the raised and recessed portion 2f of the front barrel 2 in the rotational direction, and the springy force given by the cutout 11f energizes the elastic projection 11e in the radial direction, thereby causing the elastic projection 11e and the raised and recessed portion 2f to repeatedly engage with and disengage from (i.e. mesh with and release mesh with) each other. When the relative rotation in the first direction is made in a state where the elastic projection 11e and the raised and recessed portion 2f are engaged with each other in the rotational direction, the inclined surface 11e1 of the elastic projection 11e comes into contact with the inclined surface 2f1 of the raised and recessed portion 2f, and in this state, the inclined surface 11e1 slides upward along the inclined surface 2f1.

After the elastic projection 11e climbs over a raised portion of the raised and recessed portion 2f, the elastic projection 11e and the raised and recessed portion 2f are engaged with each other in the rotational direction again. As a result, the user experiences a clicking or ratcheting sensation every time the elastic projection 11e and the raised and recessed portion 2f are engaged with and disengaged from each other. In some examples including 24 raised and recessed portions arranged in the circumferential direction in the raised and recessed portion 2f, the click feeling is given to the user every time a relative rotation is made in the first direction by 15°.

On the other hand, when the user tries to rotate the main body barrel 3 relative to the front barrel 2 in a second direction (e.g. counterclockwise) opposite to the first direction, the side surface 11e2 of the elastic projection 11e constituting part of the ratchet mechanism 12 comes into contact with the side surface 2f2 of the raised and recessed portion 2f to restrict a relative rotation in the second direction. This prevents the main body barrel 3 and the front barrel 2 from relatively rotating in the second (opposite) direction. That is, a rotational force (i.e. torque) in relative rotation in the first direction is set to a force that allows rotation to be readily made, and a rotational force in relative rotation in the second, opposite direction is set to a force that makes rotation difficult in relationship to the first direction. For example, when the outer diameter of the main body barrel 3 is designed to be about 14 mm, a torque associated with the relative rotation in the first direction may be set to 0.1 N·m (i.e. newton meter) or less, and a torque associated with the relative rotation in the second direction may be set to 0.2 N·m or more.

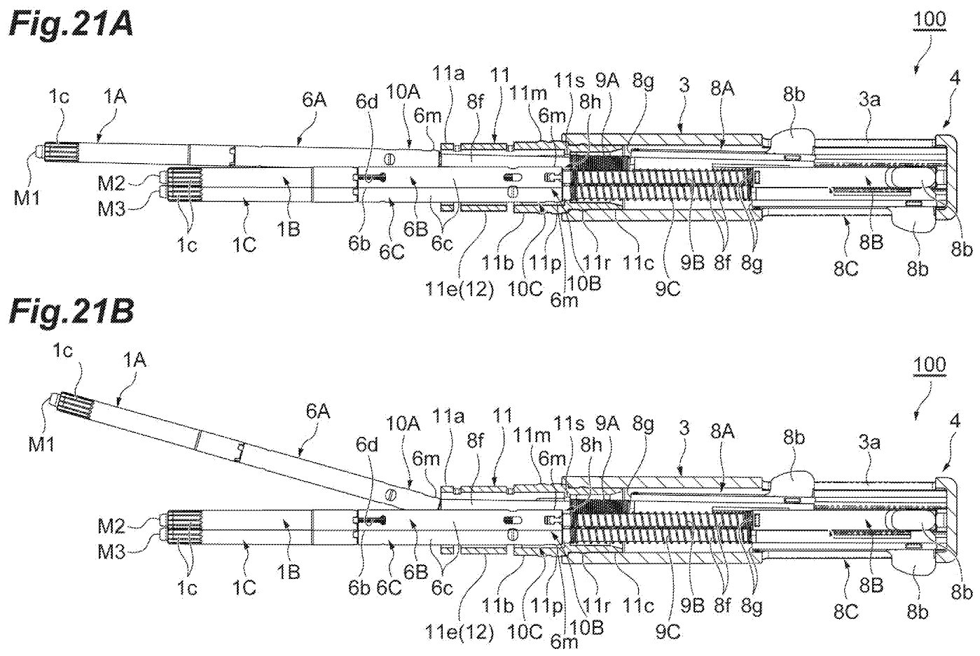

An example operation of detaching the cartridge 10 from the slider 8 of the main body 4 is described below. FIG. 21A is a partial longitudinal cross-sectional view of the feeding pencil 100, illustrating a state where the front barrel 2 is detached from the main body barrel 3, and the slider 8A is moved forward by the fixed amount relative to the main body barrel 3. FIG. 21B is a partial longitudinal cross-sectional view of the feeding pencil 100, illustrating a state where the cartridge 10A is tilted from the slider 8A illustrated in FIG. 21A.

When the cartridge 10A is detached from the main body 4, the slider 8A is moved forward by a fixed amount relative to the main body barrel 3 with the front barrel 2 detached from the main body barrel 3 to expose the four cartridges 10. This brings the cartridge 10A into a state where the cartridge 10A is pushed forward relative to the other cartridges 10. Next, the cartridge 10A pushed forward is tilted toward one side in the radial direction relative to the slider 8A.

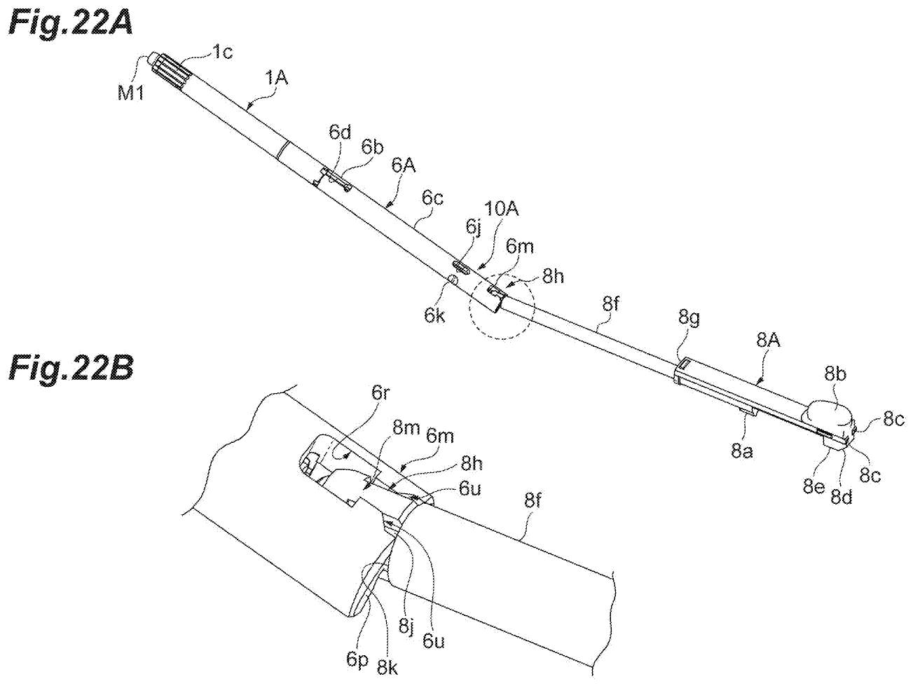

FIG. 22A is a perspective view of the cartridge 10A and the slider 8A in the state illustrated in FIG. 21B, and FIG. 22B is an enlarged perspective view of main portions of the cartridge 10A and the slider 8A (a portion enclosed by the dashed line in FIG. 22A). When the cartridge 10A is tilted toward one side in the radial direction relative to the slider 8A (e.g. a side where the slit 6r and the projection 8m are located relative to the axis), the pair of raised portions 6u of the slit 6r come into contact with the outer peripheral surface 8j of the insertion portion 8h.

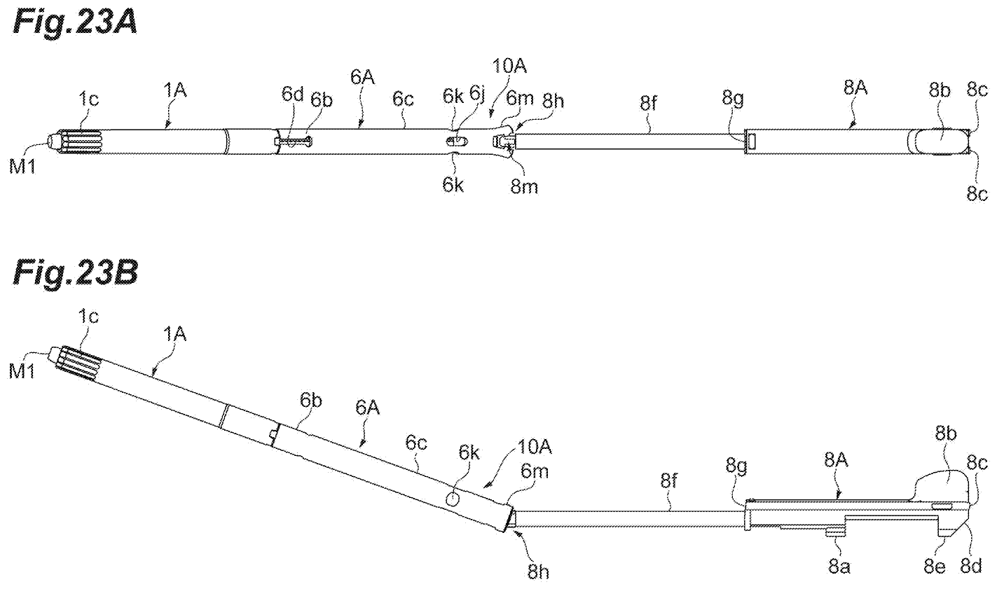

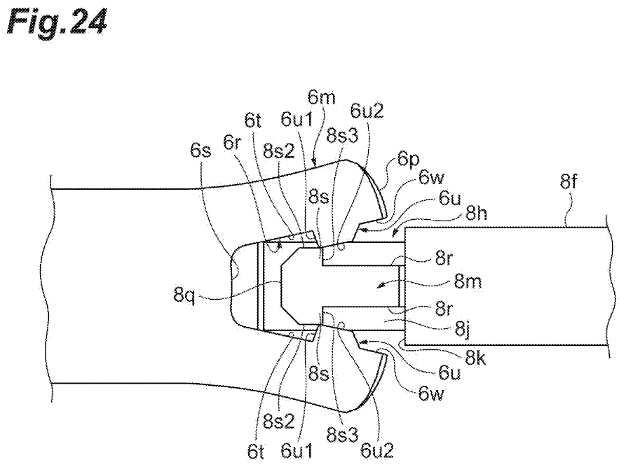

FIG. 23A is a side view of the cartridge 10A and the slider 8A, illustrating a state where the cartridge 10A is further tilted from the slider 8A illustrated in FIG. 22A, and FIG. 23B is a side view of the cartridge 10A and the slider 8A as viewed from a direction different from the direction of FIG. 23A. FIG. 24 is an enlarged side view of main portions of the cartridge 10A and the slider 8A. When the cartridge 10A is tilted further relative to the slider 8A, the pair of raised portions 6u of the slit 6r press against the outer peripheral surface 8j of the insertion portion 8h, and accordingly a reaction force is applied to the pair of raised portions 6u from the outer peripheral surface 8j.

This reaction force causes the tubular portion 6m to elastically deform and expand outward in the radial direction. Accordingly, the pair of raised portions 6u move away from the pair of side surfaces 8r of the projection 8m while being in contact with the outer peripheral surface 8j. Then, the front end surface 6u1 of each of the raised portions 6u is shifted from the position opposing the rear end surface 8s3 of a corresponding one of the raised portions 8s, and the raised portion 6u climbs over the corresponding raised portion 8s and forward. This releases the engagement in the axial direction of the projection 8m and the slit 6r. Thereafter, the elastic deformation of the tubular portion 6m inward in the radial direction causes the tubular portion 6m that has been expanded to elastically return to the original shape.

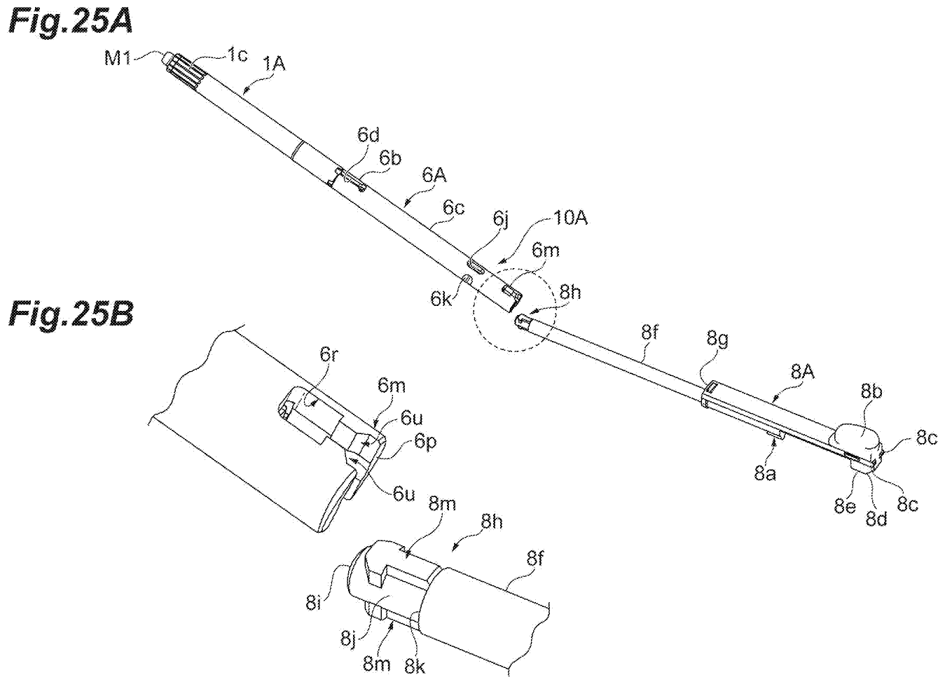

FIG. 25A is a perspective view of the cartridge 10A and the slider 8A, illustrating a state where the cartridge 10A is detached from the slider 8A, and FIG. 25B is an enlarged perspective view of main portions of the cartridge 10A and the slider 8A, (e.g. a portion enclosed by the dashed line in FIG. 25A). When the cartridge 10A is moved away from the slider 8A in the state illustrated in FIG. 24, the tubular portion 6m is separated from the insertion portion 8h, and the cartridge 10A is detached from the slider 8A.

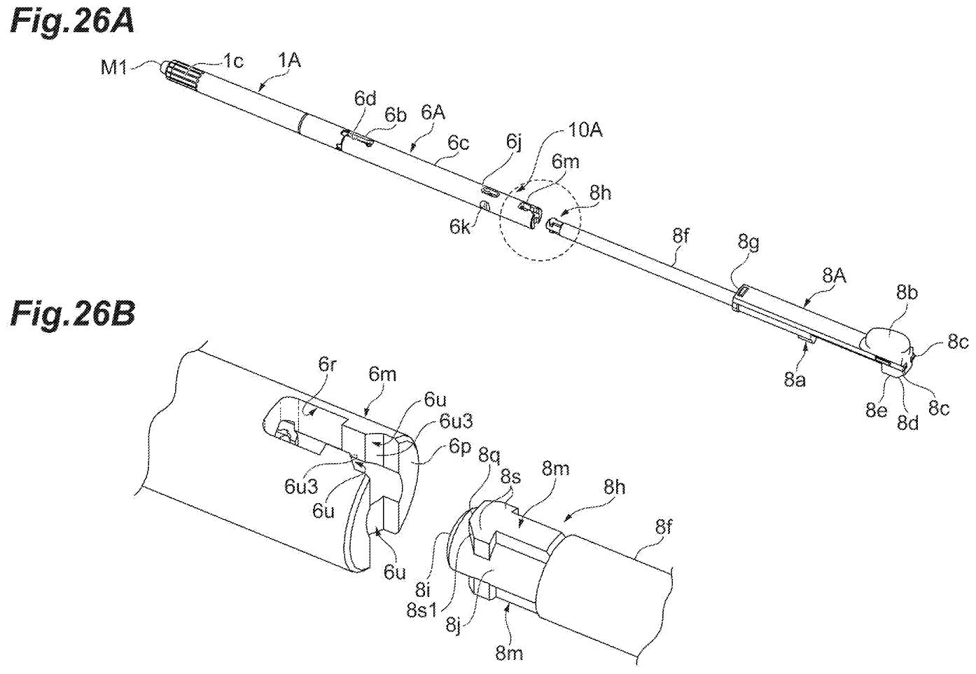

An example operation of attaching the cartridge 10 to the slider 8 is described below. FIG. 26A is a perspective view of the cartridge 10A and the slider 8A, illustrating a state before the cartridge 10A is attached to the slider 8A, and FIG. 26B is an enlarged perspective view of main portions of the cartridge 10A and the slider 8A, (e.g. a portion enclosed by the dashed line in FIG. 26A). When the cartridge 10A is attached to the slider 8A, the cartridge 10A is disposed adjacent the slider 8A in the axial direction to align the slit 6r with the projection 8m in the circumferential direction. Thereafter, the insertion portion 8h is inserted into the tubular portion 6m from the rear.

When the insertion portion 8h is inserted into the tubular portion 6m, the projection 8m is inserted into the slit 6r from the rear. Accordingly, the tapered surface 6u3 of each of the raised portions 6u comes into contact with the tapered surface 8s1 of a corresponding one of the raised portions 8s. When the tapered surface 6u3 comes into contact with the tapered surface 8s1, a reaction force is applied to the tapered surface 6u3 from the tapered surface 8s1. This reaction force causes the tubular portion 6m to elastically deform and expand the slit 6r. At this time, the tapered surface 6u3 slides upward along the tapered surface 8s1 with the tapered surface 6u3 in contact with the tapered surface 8s1.

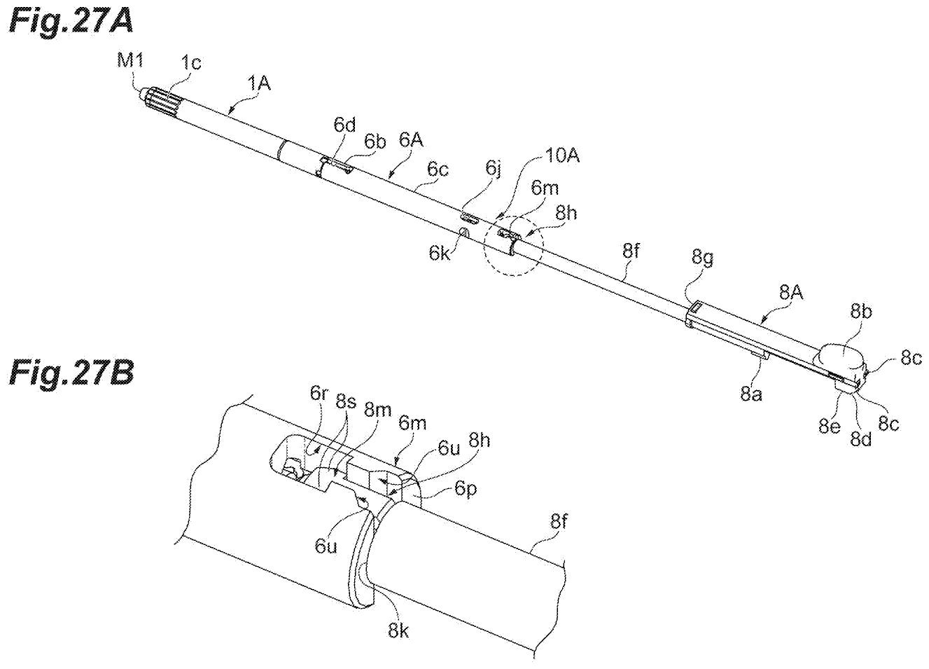

FIG. 27A is a perspective view of the cartridge 10A and the slider 8A, illustrating a state where the cartridge 10A is attached to the slider 8A, and FIG. 27B is an enlarged perspective view of main portions of the cartridge 10A and the slider 8A (e.g. a portion enclosed by the dashed line in FIG. 27A). After each of the raised portions 6u of the slit 6r climbs over a corresponding one of raised portions 8s of the projection 8m rearward, the elastic deformation of the tubular portion 6m inward in the radial direction causes the tubular portion 6m to elastically return to the original shape, thereby causing each of the raised portions 6u of the slit 6r that has been expanded to return to the original position. This causes the slit 6r and the projection 8m to engage with each other in the axial direction. In some examples, each of the raised portions 8s of the projection 8m enters a space in front of a corresponding one of the raised portions 6u of the slit 6r and is brought into a state where the raised portion 8s is caught in the raised portion 6u in the axial direction so that the cartridge 10A is attached to the slider 8A.

Example operations for detaching the cartridge 10A from the main body 4 (e.g. slider 8A) and for attaching the cartridge 10A to the main body 4 have been described above. For each of the other cartridges such as the cartridges 10B and 10C, detachment from and attachment to the main body 4 may be made by the same or similar operations.

In an example feeding pencil 100, the engagement in the axial direction between the slit 6r of the tubular portion 6m and the projection 8m of the insertion portion 8h is released when the cartridge 10 is tilted from the slider 8. This action of release or disengagement allows the cartridge 10 to detach from the slider 8. Accordingly, the operation of tilting cartridge 10 relative to the slider 8 allows the cartridge 10 to detach from the slider 8 without rotating the cartridge 10, for example. This allows the cartridge 10 to be readily attached and detached from the slider 8, to facilitate manufacturing operations at the time of assembly of the feeding pencil 100.

When the cartridge 10 is tilted from the slider 8 with the front barrel 2 detached from the main body barrel 3 and the slider 8 moved forward by the fixed amount relative to the main body barrel 3, the engagement between the slit 6r of the tubular portion 6m and the projection 8m of the insertion portion 8h is released. In some examples, the cartridge 10 can be readily detached from the slider 8 with the front barrel 2 detached from the main body barrel 3 and the slider 8 moved forward by the fixed amount. Further, the cartridge 10 may be firmly or securely engaged with the slider 8 to prevent the cartridge 10 from inadvertently detaching from the slider 8 while in use.

In some examples, the front barrel 2 is engaged with the main body barrel 3 so as to be rotatable relative to the main body barrel 3. The slider 8 may be moved forward by the fixed amount relative to the main body barrel 3 to cause the pipe member 1 to engage with the front barrel 2 in the rotational direction. Additionally, the front barrel 2 and the main body barrel 3 may be relatively rotated in one direction with the pipe member 1 engaged with the front barrel 2 in the rotational direction, thereby causing the drawing material M to move forward in the front barrel 2. In some examples, when the slider 8 is moved forward by the fixed amount relative to the main body barrel 3, the pipe member 1 is moved forward accordingly. Then, with the pipe member 1 engaged with the front barrel 2 in the rotational direction, the relative rotation between the front barrel 2 and the main body barrel 3 in the one direction causes the drawing material M to move forward. In some examples, a structure in which the drawing material M is moved forward by the relative rotation between the front barrel 2 and the main body barrel 3 may exhibit the same or similar effects.

In some examples, the tubular portion 6m in which a slit 6r is formed is provided on the rear side of the cartridge 10 (for example, the rear end portion of the holder 6), and the insertion portion 8h including the projection 8m configured to be engaged with the slit 6r in the axial direction is provided on the front side of the main body 4 (e.g. the front end portion of the slider 8). The tubular portion 6m and the insertion portion 8h may be configure to facilitate an engagement between the cartridge 10 and the main body 4. When the tubular portion in which the slit is formed is provided on the front side of the main body rather than the cartridge 10, the cartridge may be detached by being tilted from the main body in which the slit is formed, which may decrease the mechanical strength of the main body due to repeated attachment and detachment. This in turn may decrease the strength of the engagement between the cartridge and the main body, or the integrity of the main body may be compromised. On the other hand, for examples in which the tubular portion 6m in which the slit 6r is formed is provided on the rear side of the cartridge 10, the mechanical strength of the main body 4 (insertion portion 8h) may be maintained despite repeated attachment and detachment.

When the cartridge 10 is tilted from the slider 8, the tubular portion 6m is separated from the insertion portion 8h while the outer peripheral surface 8j of the insertion portion 8h causes the tubular portion 6m to expand (see FIG. 24). Accordingly, the cartridge 10 may detach from the slider 8. In some examples, the insertion portion 8h can expand the slit 6r. Therefore, when the cartridge 10 is tilted from the slider 8, the tubular portion 6m is expanded by the outer peripheral surface 8j of the insertion portion 8h. This expansion causes the tubular portion 6m to separate from the insertion portion 8h, and accordingly causes the cartridge 10 to detach from the slider 8. The structure of the cartridge 10 and the slider 8 can be simplified.

In some examples, the insertion portion 8h has a cylindrical shape to prevent, when the cartridge 10 is detached from the slider 8 by being tilted from the slider 8, the pair of raised portions 6u of the tubular portion 6m from being caught in the outer peripheral surface 8j of the insertion portion 8h. Additionally, the cylindrical shape of the insertion portion 8h may facilitate the cartridge 10 to be more readily detachable and/or to maintain the mechanical strength of the insertion portion 8h.

In some examples, the projection 8m and the slit 6r are located on opposite sides of the tubular portion 6m from each other in the radial direction of the tubular portion 6m. This configuration allows the cartridge 10 to detach from the slider 8 by being tilted to not only one side in the radial direction but also the opposite side. This in turn allows the cartridge 10 to readily detach from the slider 8.

Providing the projection 8m and the slit 6r at three, four, five, or six or more positions in the circumferential direction may increase the number of directions in which the cartridge 10 is tilted to detach from the slider 8. On the other hand, as described above, providing the projection 8m and the slit 6r at two positions may maintain the mechanical strength of the tubular portion 6m.

It is to be understood that not all aspects, advantages and features described herein may necessarily be achieved by, or included in, any one particular example. Indeed, having described and illustrated various examples herein, it should be apparent that other examples may be modified in arrangement and detail. For example, the first engagement portion need not be the tubular portion 6m, and the second engagement portion need not be the insertion portion 8h.

In some examples, the tubular portion 6m is provided at the rear end portion of the holder 6, and the insertion portion 8h is provided at the front end portion of the slider 8. However, the insertion portion may be provided at the rear end portion of the holder, and the tubular portion may be provided at the front end portion of the slider. Further, insertion portion 8h may have a polygonal pillar shape such as a triangular pillar shape, a square pillar shape, a pentagonal pillar shape, or a hexagonal pillar shape.

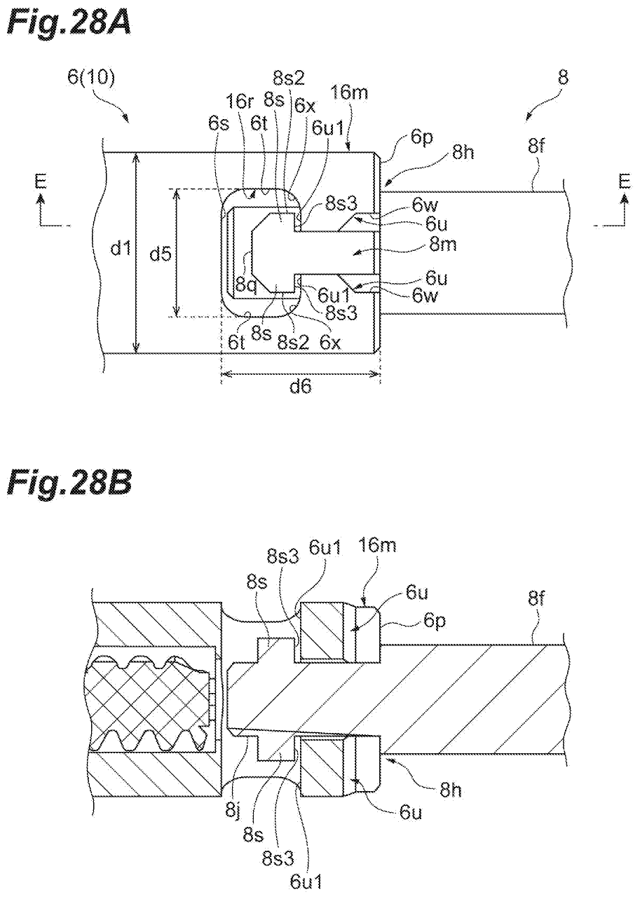

FIG. 28A is a side view of an example tubular portion 16m and the insertion portion 8h in which the insertion portion 8h is engaged with the tubular portion 16m in the axial direction, and FIG. 28B is a cross-sectional view taken along line E-E of FIG. 28A. In the example tubular portion 16m of FIG. 28A, a front portion of a slit 16r is expanded as viewed from the radial direction, and accordingly the elasticity of the tubular portion 16m may be selectively adjusted. For example, the front portion of the slit 16r may be larger in width than a rear portion of the slit 16r.

A distance d5 between a pair of inner wall surfaces 6t of the slit 16r may be larger than the distance between a pair of inner wall surfaces 6w. In some examples, the inner wall surface 6t of the slit 16r is provided at a position distanced from the reference line extending in the axial direction through the center of the slit 16r as compared with the inner wall surface 6w. The distance d5 between the pair of inner wall surfaces 6t of the slit 16r is, for example, approximately 2.1 mm. The distance d5 is in a range of, for example, 40% to 80% of an outer diameter d1 of the tubular portion 16m. Further, the distance d5 is larger than the distance between the pair of top surfaces 8s2, and the inner wall surface 6t of the slit 16r opposes the top surface 8s2 of the raised portion 8s with a predetermined distance therebetween.

Located at a connecting portion between the front end surface 6u1 of the raised portion 6u and the inner wall surface 6t in the slit 16r is a curved surface 6x extending in a curved form in the axial direction and the circumferential direction. The curved surface 6x makes may be configured to suppress concentration of stress on a corresponding connecting portion between the inner wall surface 6t and the front end surface 6u1 when the tubular portion 16m is expanded. Further, in the slit 16r, a distance d6 in the axial direction between the inner wall surface 6s and the rear end surface 6p (i.e. a length in the axial direction of the slit 16r) may be smaller than the distance d2 between the inner wall surface 6s and the rear end surface 6p, for example. The distance d6 between the inner wall surface 6s and the rear end surface 6p is, for example, approximately 2.6 mm. The distance d6 is in a range of, for example, 50% to 100% of the outer diameter d1 of the tubular portion 16m.

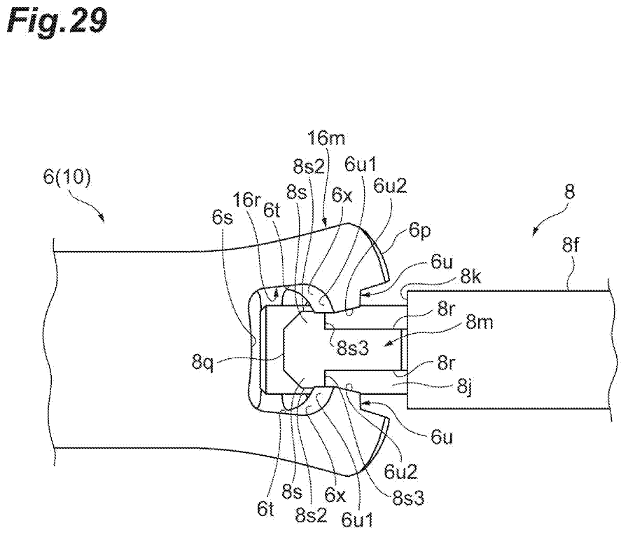

FIG. 29 is a side view of the cartridge 10 and the slider 8, illustrating a state where the cartridge 10 is tilted from the slider 8 of FIG. 28A. When the cartridge 10 is tilted from the slider 8, the pair of raised portions 6u of the slit 16r of the tubular portion 16m come into contact with the outer peripheral surface 8j of the insertion portion 8h and are pressed against the outer peripheral surface 8j. Then, a reaction force is applied to the pair of raised portions 6u from the outer peripheral surface 8j to cause the tubular portion 16m to elastically deform and expand outward in the radial direction. Accordingly, the amount (degree) of elastic deformation of the tubular portion 16m is selectively adjusted by a degree of expansion of the front portion of the slit 16r. Thereafter, the engagement between the projection 8m and the slit 16r in the axial direction may be released or detached.

Although the pair of slits 6r located on opposites sides from each other in the radial direction are provided symmetrically in the radial direction, the slits 6r may be provided asymmetrically. Further, the pair of raised portions 6u of the slit 6r may be provided asymmetrically in the circumferential direction. Still further, the pair of raised portions 8s of the projection 8m may be provided asymmetrically in the circumferential direction.

The projection 8m and the slit 6r may be located at positions other than the opposite sides of the insertion portion 8h and the cartridge 10A, respectively. For example, the projection 8m and the slit 6r may be provided at one position, and in some examples a different number and arrangement of the projections 8m and the slits 6r may be included. Further, the raised portion 6u and the raised portion 8s may have an arc shape as viewed from the radial direction. The raised portion 6u may include a vertical surface extending in the radial direction and the circumferential direction, rather than the tapered surface 6u3. Additionally, the raised portion 8s may include a vertical surface extending in the radial direction and the circumferential direction, rather than the tapered surface 8s1.

In some examples, the feeding pencil 100 includes the rotary push-out structure in which the drawing material M is moved forward by relative rotation between the front barrel 2 and the main body barrel 3. In other examples, the feeding pencil 100 may include a retractable push-out mechanism in which the drawing material M is moved forward by a retractable mechanism. When the cartridge 10 is detached from the slider 8 by being tilted from the slider 8, the slider 8 may be moved forward by the fixed amount relative to the main body barrel 3. In other examples, the slider 8 may not be moved forward by the fixed amount relative to the main body barrel 3. When the cartridge 10 is tilted from the slider 8 of the main body 4, the engagement in the axial direction between the tubular portion 6m and the insertion portion 8h is released. However, the engagement may instead be released when the cartridge 10 is tilted relative to another member of the main body 4 rather than the slider 8. In some examples, the engagement may be released when the cartridge 10 is tilted relative to the middle barrel provided in the main body 4.

In some examples, the annular raised portion 2g, the annular recessed portion 2h located in front of the annular raised portion 2g, and the annular recessed portion 2j located behind the annular raised portion 2g are provided on the inner surface of the front barrel 2. However, in some examples, either one of the annular recessed portion 2h or the annular recessed portion 2j may be omitted. For example, at least one of the front side of the annular raised portion 2g and the rear side of the annular raised portion 2g may be a flat surface.

In some examples, the projection 11m provided on the outer surface of the middle barrel 11 and the annular raised portion 2g provided on the inner surface of the front barrel 2 are detachably engaged with each other in the axial direction. However, in place of the projection 11m and the annular raised portion 2g, an annular raised portion and a projection may be formed on the outer surface of the middle barrel 11 and on the inner surface of the front barrel 2, respectively. Additionally, the annular raised portion on the outer surface of the middle barrel 11 and the projection on the inner surface of the front barrel 2 may be detachably engaged with each other in the axial direction.

As illustrated in FIG. 14A and FIG. 14B, the ridge 1b may be provided on the inner surface of the pipe member 1 in front of the female thread 1a and at four positions equally distanced from each other in the circumferential direction to prevent the drawing material M loaded in the pipe member 1 from coming off. However, the drawing material M may be prevented from coming off without the ridge 1b.

For example, in place of the ridge 1b, a treatment for increasing a friction coefficient may be applied to the inner surface of the pipe member 1, or the inner surface of the pipe member 1 may have a noncircular shape such as a polygonal shape to prevent the drawing material M from coming off.

In some examples, the feeding pencil 100 may include drawing materials having different thicknesses from each other, or may include a plurality of drawing materials having different composition or use from each other. In some examples, the number of drawing materials may be two, three, four, five or more.

The feeding pencil may include a multi-color pencil. In some examples, the feeding pencil may include one drawing material and one cartridge. Further, the configuration of the cartridge need not include all of the components of the pipe member, the mobile body, and the holder, and some or all of the components may be replaced with different components, or, a different component may be added.

What is claimed is:

1. A feeding pencil comprising:
a main body including a main body barrel having a tubular shape;
a front barrel configured to be detachably engaged with the main body barrel; and
a cartridge disposed in the front barrel for receiving a drawing material,
wherein the cartridge includes a first engagement portion provided on a rear side of the cartridge, and
wherein the main body includes a second engagement portion provided on a front side of the main body and configured to be engaged with the first engagement portion, so that when the cartridge is tilted from the main body, an engagement between the first engagement portion and the second engagement portion is released.

2. The feeding pencil according to claim 1, wherein the engagement of the first engagement portion and the second engagement portion includes a tubular portion having a cutout hole formed through the tubular portion, and an insertion portion configured to be inserted into and engaged with the cutout hole.

3. The feeding pencil according to claim 2, wherein the first engagement portion comprises the tubular portion, and
wherein the second engagement portion comprises the insertion portion.

4. The feeding pencil according to claim 2, wherein, when the cartridge is tilted from the main body to cause the tubular portion to separate from the insertion portion while causing the insertion portion to expand the tubular portion, the cartridge is detached from the main body.

5. The feeding pencil according to claim 4, wherein the insertion portion has a cylindrical shape.

6. The feeding pencil according to claim 4, wherein a projection is formed on an outer surface of the insertion portion,
wherein a raised portion is formed on an inner wall surface of the cutout hole, the projection being engaged with the raised portion, and
wherein the projection and the raised portion are located on opposite sides of the tubular portion from each other in a radial direction of the tubular portion.

7. The feeding pencil according to claim 2, wherein the insertion portion has a cylindrical shape.

8. The feeding pencil according to claim 2, wherein a projection is formed on an outer surface of the insertion portion,
wherein a raised portion is formed on an inner wall surface of the cutout hole, the projection being engaged with the raised portion, and
wherein the projection and the raised portion are located on opposite sides of the tubular portion from each other in a radial direction of the tubular portion

9. The feeding pencil according to claim 1, wherein the main body further includes a slider provided in the main body barrel and slidable by a fixed amount relative to the main body barrel,
wherein the slider is disposed behind the cartridge, and
wherein the second engagement portion is provided on a front side of the slider, so that when the cartridge is tilted from the slider with the front barrel detached from the main body barrel and the slider moved forward by the fixed amount relative to the main body barrel, the engagement between the first engagement portion and the second engagement portion is released.

10. The feeding pencil according to claim 9, wherein the engagement of the first engagement portion and the second engagement portion includes a tubular portion having a cutout hole formed through the tubular portion, and an insertion portion configured to be inserted into and engaged with the cutout hole.

11. The feeding pencil according to claim 10, wherein, when the cartridge is tilted from the main body to cause the tubular portion to separate from the insertion portion while causing the insertion portion to expand the tubular portion, the cartridge is detached from the main body.

12. The feeding pencil according to claim 10, wherein a projection is formed on an outer surface of the insertion portion,
wherein a raised portion is formed on an inner wall surface of the cutout hole, the projection being engaged with the raised portion, and
wherein the projection and the raised portion are located on opposite sides of the tubular portion from each other in a radial direction of the tubular portion.

13. The feeding pencil according to claim 9, wherein the front barrel is engaged with the main body barrel and is rotatable relative to the main body barrel,
wherein the cartridge includes:
a pipe member loaded with the drawing material;
a mobile body configured to push out the drawing material loaded in the pipe member forward; and
a holder configured to hold the mobile body behind the pipe member,
wherein the slider is moved forward by the fixed amount relative to the main body barrel to cause the pipe member to engage with the front barrel in a rotational direction, and
wherein relative rotation between the front barrel and the main body barrel in one direction with the pipe member engaged with the front barrel in the rotational direction causes the drawing material to move forward in the front barrel.

14. The feeding pencil according to claim 13, wherein the engagement of the first engagement portion and the second engagement portion includes a tubular portion having a cutout hole formed through the tubular portion, and an insertion portion configured to be inserted into and engaged with the cutout hole.

15. The feeding pencil according to claim 14, wherein the first engagement portion comprises the tubular portion, and
wherein the second engagement portion comprises the insertion portion.

16. The feeding pencil according to claim 14, wherein, when the cartridge is tilted from the main body to cause the tubular portion to separate from the insertion portion while causing the insertion portion to expand the tubular portion, the cartridge is detached from the main body.

17. The feeding pencil according to claim 14, wherein the insertion portion has a cylindrical shape.

18. The feeding pencil according to claim 14, wherein a projection is formed on an outer surface of the insertion portion,
wherein a raised portion is formed on an inner wall surface of the cutout hole, the projection being engaged with the raised portion, and
wherein the projection and the raised portion are located on opposite sides of the tubular portion from each other in a radial direction of the tubular portion.
